(19) United States
(12) Patent Application Publication
(10) Pub. No.: US 2026/0323437 A1
(43) Pub. Date: Oct. 15, 2026

(54) TRANSMISSION CONFIGURATION INDICATOR ACTIVATION IN A CANDIDATE CELL

(71) Applicant: QUALCOMM Incorporated, San Diego, CA (US)

(72) Inventors: Fang YUAN, Beijing (CN); Yan ZHOU, San Diego, CA (US)

(21) Appl. No.: 19/483,827

(22) PCT Filed: Jul. 14, 2023
(86) PCT No.: PCT/CN2023/107379

§ 371 Date: Nov. 12, 2025

(51) Int. Cl. H04W 36/04; H04W 36/00; H04W 72/231

(52) U.S. Cl. CPC H04W 36/04; H04W 36/0055; H04W 72/231

(57) ABSTRACT

Methods, systems, and devices for wireless communications are described. A wireless communication system may support TCI activation in a candidate cell. The described techniques provide for indicating or determining one or more bandwidth parts (BWPs), indicating or determining one or more BWPs for one or more quasi co-located (QCL'd) source reference signals, indicating or determining activation of one or more TCI states, or indicating or determining one or more TCI state application times. A user equipment (UE) may receive, via a serving cell, control information that is indicative of one or more BWPs for use in communications with a candidate serving cell. The one or more BWPs may be associated with an activated TCI state of the candidate serving cell. The UE may receive a cell switch command that indicates for the UE to switch to the candidate cell via a cell switching procedure.

### CROSS REFERENCE

The present application for patent is a 371 national phase filing of International Patent Application No. PCT/CN2023/107379 by YUAN et al., entitled “TRANSMISSION CONFIGURATION INDICATOR ACTIVATION IN A CANDIDATE CELL,” filed Jul. 14, 2023, assigned to the assignee hereof, and expressly incorporated by reference herein.

### FIELD OF TECHNOLOGY

The following relates to wireless communications, including transmission configuration indicator activation in a candidate cell.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support transmission configuration indicator (TCI) activation in a candidate cell. For example, the described techniques provide for indicating or determining one or more bandwidth parts (BWPs), indicating or determining one or more BWPs for one or more quasi co-located (QCL'd) source reference signals, indicating or determining activation of one or more TCI states, indicating or determining one or more TCI state application times, or one or more combinations thereof.

In some examples, a user equipment (UE) may receive, via a serving cell (e.g., a source serving cell), control information that is indicative of one or more BWPs for use in communications with a candidate serving cell (e.g., a target serving cell). The one or more BWPs may be associated with an activated TCI state of the candidate serving cell. The UE may receive control information that identifies a BWP of the candidate serving cell. For instance, the UE may receive an explicit indication of downlink or uplink BWP identifiers for a candidate cell (e.g., in a TCI activation medium access control-control element (MAC-CE) or in a cell switching MAC-CE). Alternatively, or in addition, the UE may determine the one or more BWPs based on a rule (e.g., an implicit rule) applied to the control information. For instance, the rule may indicate the BWP based on an association of a BWP with the activated TCI state. Or, the rule may indicate that the BWP includes one, some, or all BWPs within the bandwidth of the candidate serving cell when the control information lacks an indication of the BWP.

In some examples, a BWP for a QCL'd source reference signal of the activated TCI state of the candidate serving cell may be indicated, either explicitly or implicitly (by rule). In some examples, the UE may receive, via a serving cell, a cell switch command indicating that the UE is to switch to a candidate cell via a layer 1 or layer 2 triggered mobility (LTM) cell switching procedure. In order to determine which TCI state to use for the switch, the UE may determine whether the TCI activation information is received with the cell switch command or before the cell switch command.

A method for wireless communication by a UE is described. The method may include receiving, via a serving cell, control information that is indicative of one or more BWPs, where the one or more BWPs are associated with an activated TCI state of a candidate cell, receiving, via the serving cell, a cell switch command that indicates for the UE to switch to the candidate cell via an LTM cell switching procedure, and communicating one or more messages with the candidate cell in accordance with the cell switch command and the activated TCI state using the one or more BWPs of the candidate cell.

A UE for wireless communication is described. The UE may include at least one processor, memory coupled (e.g., operatively, communicatively, functionally, electronically, or electrically) with the at least one processor, and instructions stored in the memory. The instructions may be executable by the at least one processor (e.g., directly, indirectly, after pre-processing, without pre-processing) to cause the UE to receive, via a serving cell, control information that is indicative of one or more BWPs, where the one or more BWPs are associated with an activated TCI state of a candidate cell, receive, via the serving cell, a cell switch command that indicates for the UE to switch to the candidate cell via an LTM cell switching procedure, and communicate one or more messages with the candidate cell in accordance with the cell switch command and the activated TCI state using the one or more BWPs of the candidate cell.

Another UE for wireless communication is described. The UE may include means for receiving, via a serving cell, control information that is indicative of one or more BWPs, where the one or more BWPs are associated with an activated TCI state of a candidate cell, means for receiving, via the serving cell, a cell switch command that indicates for the UE to switch to the candidate cell via an LTM cell switching procedure, and means for communicating one or more messages with the candidate cell in accordance with the cell switch command and the activated TCI state using the one or more BWPs of the candidate cell.

A non-transitory computer-readable medium storing code for wireless communication is described. The code may include instructions executable by at least one processor (e.g., directly, indirectly, after pre-processing, without pre-processing) to receive, via a serving cell, control information that is indicative of one or more BWPs, where the one or more BWPs are associated with an activated TCI state of a candidate cell, receive, via the serving cell, a cell switch command that indicates for the UE to switch to the candidate cell via an LTM cell switching procedure, and communicate one or more messages with the candidate cell in accordance with the cell switch command and the activated TCI state using the one or more BWPs of the candidate cell.

In some examples of the method, UEs, and non-transitory computer-readable medium described herein, the one or more BWPs may be indicated by inclusion, in the control information, of a BWP identifier of the candidate cell and the control information may be received via a TCI activation MAC-CE or via a cell switch MAC-CE.

In some examples of the method, UEs, and non-transitory computer-readable medium described herein, association of the one or more BWPs with the activated TCI state may be via a rule applied to the control information.

In some examples of the method, UEs, and non-transitory computer-readable medium described herein, the control information may be received via a radio resource control (RRC) configuration message and the rule indicates that the one or more BWPs include a first active BWP configured via the RRC configuration message or an initial BWP configured via the RRC configuration message.

In some examples of the method, UEs, and non-transitory computer-readable medium described herein, the control information may be an indication of the activated TCI state and may be received separate from candidate cell configuration signaling and serving cell configuration signaling and lacks an indication of the one or more BWPs and the rule indicates that, based on lack of the indication of the one or more BWPs in the control information, the one or more BWPs include a set of multiple BWPs within a bandwidth of the candidate cell.

In some examples of the method, UEs, and non-transitory computer-readable medium described herein, the one or more BWPs may be indicated by inclusion, in the control information, of a BWP identifier for a QCL'd source reference signal of the activated TCI state of the candidate cell, and where the control information may be received via an RRC configuration message.

In some examples of the method, UEs, and non-transitory computer-readable medium described herein, association of the one or more BWPs with a QCL'd source reference signal of the activated TCI state may be via a rule applied to the control information.

In some examples of the method, UEs, and non-transitory computer-readable medium described herein, the control information may be received via an RRC configuration message and the rule indicates that the one or more BWPs, associated with the QCL'd source reference signal, include a first active BWP configured via the RRC configuration message or an initial BWP configured via the RRC configuration message.

In some examples of the method, UEs, and non-transitory computer-readable medium described herein, the control information may be an indication of the activated TCI state and may be received separate from candidate cell configuration signaling and serving cell configuration signaling and lacks an indication of the one or more BWPs and the rule indicates that, based on lack of the indication of the one or more BWPs in the control information, the one or more BWPs include a set of multiple BWPs, for the QCL'd source reference signal, within a bandwidth of the candidate cell.

In some examples of the method, UEs, and non-transitory computer-readable medium described herein, the QCL'd source reference signal may be configured as a channel state information reference signal (CSI-RS) for mobility, may be configured as a CSI-RS with an associated frequency allocation, or may be configured as a synchronization signal block (SSB) with an associated frequency allocation.

In some examples of the method, UEs, and non-transitory computer-readable medium described herein, the activated TCI state may be one of a set of multiple activated TCI states for a corresponding set of multiple candidate cells and the method, apparatuses, and non-transitory computer-readable medium may include further operations, features, means, or instructions for determining a TCI state application time as a maximum TCI state application time among a set of multiple TCI state application times respectively associated with the set of multiple activated TCI states and with a set of multiple target cells, where communicating with the candidate cell includes communicating via at least one beam in accordance with the TCI state application time.

In some examples of the method, UEs, and non-transitory computer-readable medium described herein, the activated TCI state may be one of a set of multiple activated TCI states for a corresponding set of multiple candidate cells and the method, apparatuses, and non-transitory computer-readable medium may include further operations, features, means, or instructions for determining a TCI state application time as a sum of a set of multiple TCI state application times respectively associated with the set of multiple activated TCI states and with a set of multiple target cells, where communicating with the candidate cell includes communicating via at least one beam in accordance with the TCI state application time.

Some examples of the method, UEs, and non-transitory computer-readable medium described herein may further include operations, features, means, or instructions for determining a TCI state application time, an RRC application time, or a radio frequency (RF) tuning time based on a quantity of target cells, where the TCI state application time, the radio resource control application time, or the RF tuning time increases with an increasing quantity of target cells, and where communicating with the candidate cell includes communicating in accordance with the TCI state application time, the RRC application time, or the RF tuning time.

Some examples of the method, UEs, and non-transitory computer-readable medium described herein may further include operations, features, means, or instructions for determining a respective TCI state application time for each of a set of multiple target cells, and where communicating with the candidate cell includes communicating via a set of multiple beams in accordance with the respective TCI state application time for each of the set of multiple target cells.

A method for wireless communication by a UE is described. The method may include receiving, via a serving cell, activation information that is indicative of activation of a TCI state of a candidate cell, receiving, via the serving cell, a cell switch command for the UE to switch to the candidate cell via an LTM cell switching procedure, where a determination of a TCI state of a set of multiple TCI states is based on whether the activation information is received with the cell switch command or before the cell switch command, and communicating with the candidate cell in accordance with the cell switch command and the TCI state.

A UE for wireless communication is described. The UE may include at least one processor, memory coupled (e.g., operatively, communicatively, functionally, electronically, or electrically) with the at least one processor, and instructions stored in the memory. The instructions may be executable by the at least one processor (e.g., directly, indirectly, after pre-processing, without pre-processing) to cause the UE to receive, via a serving cell, activation information that is indicative of activation of a TCI state of a candidate cell, receive, via the serving cell, a cell switch command for the UE to switch to the candidate cell via an LTM cell switching procedure, where a determination of a TCI state of a set of multiple TCI states is based on whether the activation information is received with the cell switch command or before the cell switch command, and communicate with the candidate cell in accordance with the cell switch command and the TCI state.

Another UE for wireless communication is described. The UE may include means for receiving, via a serving cell, activation information that is indicative of activation of a TCI state of a candidate cell, means for receiving, via the serving cell, a cell switch command for the UE to switch to the candidate cell via an LTM cell switching procedure, where a determination of a TCI state of a set of multiple TCI states is based on whether the activation information is received with the cell switch command or before the cell switch command, and means for communicating with the candidate cell in accordance with the cell switch command and the TCI state.

A non-transitory computer-readable medium storing code for wireless communication is described. The code may include instructions executable by at least one processor (e.g., directly, indirectly, after pre-processing, without pre-processing) to receive, via a serving cell, activation information that is indicative of activation of a TCI state of a candidate cell, receive, via the serving cell, a cell switch command for the UE to switch to the candidate cell via an LTM cell switching procedure, where a determination of a TCI state of a set of multiple TCI states is based on whether the activation information is received with the cell switch command or before the cell switch command, and communicate with the candidate cell in accordance with the cell switch command and the TCI state.

Some examples of the method, UEs, and non-transitory computer-readable medium described herein may further include operations, features, means, or instructions for determining the TCI state based on a TCI codepoint index received via the cell switch command when the activation information may be received before the cell switch command, and where communicating with the candidate cell may be performed with one or more transmission and reception points (TRPs).

Some examples of the method, UEs, and non-transitory computer-readable medium described herein may further include operations, features, means, or instructions for determining the TCI state based on a set of multiple TCI codepoint indexes associated with different control resource set indexes, where the set of multiple TCI codepoint indexes may be received via the cell switch command when the activation information may be received before the cell switch command, and where communicating with the candidate cell may be performed with a set of multiple TRPs.

Some examples of the method, UEs, and non-transitory computer-readable medium described herein may further include operations, features, means, or instructions for determining the TCI state based on a TCI state index received via the cell switch command when the activation information may be received with the cell switch command, and where communicating with the candidate cell may be performed with a TRP.

Some examples of the method, UEs, and non-transitory computer-readable medium described herein may further include operations, features, means, or instructions for determining the TCI state based on a set of multiple TCI state indexes received via the cell switch command when the activation information may be received with the cell switch command, and where communicating with the candidate cell may be performed with a set of multiple TRPs.

In some examples of the method, UEs, and non-transitory computer-readable medium described herein, the activation information, the cell switch command, and a beam indication may be received via a MAC-CE message.

In some examples of the method, UEs, and non-transitory computer-readable medium described herein, the activation information and a beam indication may be received via at least one first MAC-CE message before the cell switch command and the cell switch command may be received via at least one second MAC-CE message.

In some examples of the method, UEs, and non-transitory computer-readable medium described herein, communicating with the candidate cell may include operations, features, means, or instructions for communicating on one or more channels with the candidate cell in accordance with the TCI state and a beam indicated via the cell switch command.

In some examples of the method, UEs, and non-transitory computer-readable medium described herein, the activated TCI state may be one of a set of multiple activated TCI states for a corresponding set of multiple candidate cells and the method, apparatuses, and non-transitory computer-readable medium may include further operations, features, means, or instructions for determining a TCI state application time as a maximum TCI state application time among a set of multiple TCI state application times respectively associated with the set of multiple activated TCI states and with a set of multiple target cells, where communicating with the candidate cell includes communicating via at least one beam in accordance with the TCI state application time.

In some examples of the method, UEs, and non-transitory computer-readable medium described herein, the activated TCI state may be one of a set of multiple activated TCI states for a corresponding set of multiple candidate cells and the method, apparatuses, and non-transitory computer-readable medium may include further operations, features, means, or instructions for determining a TCI state application time as a sum of a set of multiple TCI state application times respectively associated with the set of multiple activated TCI states and with a set of multiple target cells, where communicating with the candidate cell includes communicating via at least one beam in accordance with the TCI state application time.

Some examples of the method, UEs, and non-transitory computer-readable medium described herein may further include operations, features, means, or instructions for determining a TCI state application time, an RRC application time, or an RF tuning time based on a quantity of target cells, where the TCI state application time, the RRC application time, or the RF tuning time increases with an increasing quantity of target cells, and where communicating with the candidate cell includes communicating in accordance with the TCI state application time, the RRC application time, or the RF tuning time.

Some examples of the method, UEs, and non-transitory computer-readable medium described herein may further include operations, features, means, or instructions for determining a respective TCI state application time for each of a set of multiple target cells, and where communicating with the candidate cell includes communicating via a set of multiple beams in accordance with the respective TCI state application time for each of the set of multiple target cells.

A method for wireless communication by a network entity is described. The method may include communicating with a UE via a serving cell, transmitting, to the UE, control information that is indicative of one or more BWPs, where the one or more BWPs are associated with an activated TCI state of a candidate cell, and transmitting, to the UE, a cell switch command that indicates for the UE to switch to the candidate cell via an LTM cell switching procedure.

A network entity for wireless communication is described. The network entity may include at least one processor, memory coupled (e.g., operatively, communicatively, functionally, electronically, or electrically) with the at least one processor, and instructions stored in the memory. The instructions may be executable by the at least one processor (e.g., directly, indirectly, after pre-processing, without pre-processing) to cause the network entity to communicate with a UE via a serving cell, transmit, to the UE, control information that is indicative of one or more BWPs, where the one or more BWPs are associated with an activated TCI state of a candidate cell, and transmit, to the UE, a cell switch command that indicates for the UE to switch to the candidate cell via an LTM cell switching procedure.

Another network entity for wireless communication is described. The network entity may include means for communicating with a UE via a serving cell, means for transmitting, to the UE, control information that is indicative of one or more BWPs, where the one or more BWPs are associated with an activated TCI state of a candidate cell, and means for transmitting, to the UE, a cell switch command that indicates for the UE to switch to the candidate cell via an LTM cell switching procedure.

A non-transitory computer-readable medium storing code for wireless communication is described. The code may include instructions executable by at least one processor (e.g., directly, indirectly, after pre-processing, without pre-processing) to communicate with a UE via a serving cell, transmit, to the UE, control information that is indicative of one or more BWPs, where the one or more BWPs are associated with an activated TCI state of a candidate cell, and transmit, to the UE, a cell switch command that indicates for the UE to switch to the candidate cell via an LTM cell switching procedure.

In some examples of the method, network entities, and non-transitory computer-readable medium described herein, the one or more BWPs may be indicated by inclusion, in the control information, of a BWP identifier of the candidate cell and the control information may be transmitted via a TCI activation MAC-CE or via a cell switch MAC-CE.

In some examples of the method, network entities, and non-transitory computer-readable medium described herein, association of the one or more BWPs with the activated TCI state may be via a rule applied to the control information.

In some examples of the method, network entities, and non-transitory computer-readable medium described herein, the control information may be transmitted via an RRC configuration message and the rule indicates that the one or more BWPs include a first active BWP configured via the RRC configuration message or an initial BWP configured via the RRC configuration message.

In some examples of the method, network entities, and non-transitory computer-readable medium described herein, the control information may be an indication of the activated TCI state and may be transmitted separate from candidate cell configuration signaling and serving cell configuration signaling and lacks an indication of the one or more BWPs and the rule indicates that, based on lack of the indication of the one or more BWPs in the control information, the one or more BWPs include a set of multiple BWPs within a bandwidth of the candidate cell.

In some examples of the method, network entities, and non-transitory computer-readable medium described herein, the one or more BWPs may be indicated by inclusion, in the control information, of a BWP identifier for a QCL'd source reference signal of the activated TCI state of the candidate cell, and where the control information may be transmitted via an RRC configuration message.

In some examples of the method, network entities, and non-transitory computer-readable medium described herein, association of the one or more BWPs with a QCL'd source reference signal of the activated TCI state may be via a rule applied to the control information.

In some examples of the method, network entities, and non-transitory computer-readable medium described herein, the control information may be transmitted via an RRC configuration message and the rule indicates that the one or more BWPs, associated with the QCL'd source reference signal, include a first active BWP configured via the RRC configuration message or an initial BWP configured via the RRC configuration message.

In some examples of the method, network entities, and non-transitory computer-readable medium described herein, the control information may be an indication of the activated TCI state and may be transmitted separate from candidate cell configuration signaling and serving cell configuration signaling and lacks an indication of the one or more BWPs and the rule indicates that, based on lack of the indication of the one or more BWPs in the control information, the one or more BWPs include a set of multiple BWPs, for the QCL'd source reference signal, within a bandwidth of the candidate cell.

In some examples of the method, network entities, and non-transitory computer-readable medium described herein, the QCL'd source reference signal may be configured as a CSI-RS for mobility, may be configured as a CSI-RS with an associated frequency allocation, or may be configured as an SSB with an associated frequency allocation.

In some examples of the method, network entities, and non-transitory computer-readable medium described herein, the activated TCI state may be one of a set of multiple activated TCI states for a corresponding set of multiple candidate cells and the method, apparatuses, and non-transitory computer-readable medium may include further operations, features, means, or instructions for determining a TCI state application time as a maximum TCI state application time among a set of multiple TCI state application times respectively associated with the set of multiple activated TCI states and with a set of multiple target cells.

In some examples of the method, network entities, and non-transitory computer-readable medium described herein, the activated TCI state may be one of a set of multiple activated TCI states for a corresponding set of multiple candidate cells and the method, apparatuses, and non-transitory computer-readable medium may include further operations, features, means, or instructions for determining a TCI state application time as a sum of a set of multiple TCI state application times respectively associated with the set of multiple activated TCI states and with a set of multiple target cells.

Some examples of the method, network entities, and non-transitory computer-readable medium described herein may further include operations, features, means, or instructions for determining a TCI state application time, an RRC application time, or an RF tuning time based on a quantity of target cells, where the TCI state application time, the RRC application time, or the RF tuning time increases with an increasing quantity of target cells.

Some examples of the method, network entities, and non-transitory computer-readable medium described herein may further include operations, features, means, or instructions for determining a respective TCI state application time for each of a set of multiple target cells.

A method for wireless communication by a network entity is described. The method may include communicating with a UE via a serving cell, transmitting, to the UE, activation information that is indicative of activation of a TCI state of a candidate cell, and transmitting, to the UE, a cell switch command for the UE to switch to the candidate cell via an LTM cell switching procedure, where whether the activation information is transmitted with the cell switch command or before the cell switch command is indicative of a TCI state of a set of multiple TCI states.

A network entity for wireless communication is described. The network entity may include at least one processor, memory coupled (e.g., operatively, communicatively, functionally, electronically, or electrically) with the at least one processor, and instructions stored in the memory. The instructions may be executable by the at least one processor (e.g., directly, indirectly, after pre-processing, without pre-processing) to cause the network entity to communicate with a UE via a serving cell, transmit, to the UE, activation information that is indicative of activation of a TCI state of a candidate cell, and transmit, to the UE, a cell switch command for the UE to switch to the candidate cell via an LTM cell switching procedure, where whether the activation information is transmitted with the cell switch command or before the cell switch command is indicative of a TCI state of a set of multiple TCI states.

Another network entity for wireless communication is described. The network entity may include means for communicating with a UE via a serving cell, means for transmitting, to the UE, activation information that is indicative of activation of a TCI state of a candidate cell, and means for transmitting, to the UE, a cell switch command for the UE to switch to the candidate cell via an LTM cell switching procedure, where whether the activation information is transmitted with the cell switch command or before the cell switch command is indicative of a TCI state of a set of multiple TCI states.

A non-transitory computer-readable medium storing code for wireless communication is described. The code may include instructions executable by at least one processor (e.g., directly, indirectly, after pre-processing, without pre-processing) to communicate with a UE via a serving cell, transmit, to the UE, activation information that is indicative of activation of a TCI state of a candidate cell, and transmit, to the UE, a cell switch command for the UE to switch to the candidate cell via an LTM cell switching procedure, where whether the activation information is transmitted with the cell switch command or before the cell switch command is indicative of a TCI state of a set of multiple TCI states.

In some examples of the method, network entities, and non-transitory computer-readable medium described herein, when the activation information may be transmitted before the cell switch command, a TCI codepoint index transmitted via the cell switch command may be indicative of the TCI state.

In some examples of the method, network entities, and non-transitory computer-readable medium described herein, when the activation information may be transmitted before the cell switch command, a set of multiple TCI codepoint indexes associated with different control resource set indexes may be indicative of the TCI state, where the set of multiple TCI codepoint indexes may be transmitted via the cell switch command.

In some examples of the method, network entities, and non-transitory computer-readable medium described herein, when the activation information may be transmitted with the cell switch command, a TCI state index transmitted via the cell switch command may be indicative of the TCI state.

In some examples of the method, network entities, and non-transitory computer-readable medium described herein, when the activation information may be transmitted with the cell switch command, a set of multiple TCI state indexes transmitted via the cell switch command may be indicative of the TCI state.

In some examples of the method, network entities, and non-transitory computer-readable medium described herein, the activation information, the cell switch command, and a beam indication may be transmitted via a MAC-CE message.

In some examples of the method, network entities, and non-transitory computer-readable medium described herein, the activation information and a beam indication may be transmitted via at least one first MAC-CE message before the cell switch command and the cell switch command may be transmitted via at least one second MAC-CE message.

In some examples of the method, network entities, and non-transitory computer-readable medium described herein, the activated TCI state may be one of a set of multiple activated TCI states for a corresponding set of multiple candidate cells and the method, apparatuses, and non-transitory computer-readable medium may include further operations, features, means, or instructions for determining a TCI state application time as a maximum TCI state application time among a set of multiple TCI state application times respectively associated with the set of multiple activated TCI states and with a set of multiple target cells.

In some examples of the method, network entities, and non-transitory computer-readable medium described herein, the activated TCI state may be one of a set of multiple activated TCI states for a corresponding set of multiple candidate cells and the method, apparatuses, and non-transitory computer-readable medium may include further operations, features, means, or instructions for determining a TCI state application time as a sum of a set of multiple TCI state application times respectively associated with the set of multiple activated TCI states and with a set of multiple target cells.

Some examples of the method, network entities, and non-transitory computer-readable medium described herein may further include operations, features, means, or instructions for determining a TCI state application time, an RRC application time, or an RF tuning time based on a quantity of target cells, where the TCI state application time, the RRC application time, or the RF tuning time increases with an increasing quantity of target cells.

Some examples of the method, network entities, and non-transitory computer-readable medium described herein may further include operations, features, means, or instructions for determining a respective TCI state application time for each of a set of multiple target cells.

### BRIEF DESCRIPTION OF THE DRAWINGS

FIG. 1 shows an example of a wireless communications system that supports transmission configuration indicator (TCI) activation in a candidate cell in accordance with one or more aspects of the present disclosure.

FIG. 2 shows an example of a wireless communication system that supports TCI activation in a candidate cell in accordance with one or more aspects of the present disclosure.

FIG. 3 shows an example of a timeline for a cell switch.

FIG. 4A shows an example of a bandwidth part (BWP) identifier included in control information that supports TCI activation in a candidate cell in accordance with one or more aspects of the present disclosure;

FIG. 4B shows an example of a BWP rule that supports TCI activation in a candidate cell in accordance with one or more aspects of the present disclosure;

FIG. 5A shows an example of activation information and a cell switch command that support TCI activation in a candidate cell in accordance with one or more aspects of the present disclosure;

FIG. 5B shows an example of activation information and a cell switch command that support TCI activation in a candidate cell in accordance with one or more aspects of the present disclosure.

FIG. 6 shows an example of a process flow that supports TCI activation in a candidate cell in accordance with one or more aspects of the present disclosure;

FIG. 7 shows an example of a process flow that supports TCI activation in a candidate cell in accordance with one or more aspects of the present disclosure.

FIGS. 8 and 9 show block diagrams of devices that support TCI activation in a candidate cell in accordance with one or more aspects of the present disclosure.

FIG. 10 shows a block diagram of a communications manager that supports TCI activation in a candidate cell in accordance with one or more aspects of the present disclosure.

FIG. 11 shows a diagram of a system including a device that supports TCI activation in a candidate cell in accordance with one or more aspects of the present disclosure.

FIGS. 12 and 13 show block diagrams of devices that support TCI activation in a candidate cell in accordance with one or more aspects of the present disclosure.

FIG. 14 shows a block diagram of a communications manager that supports TCI activation in a candidate cell in accordance with one or more aspects of the present disclosure.

FIG. 15 shows a diagram of a system including a device that supports TCI activation in a candidate cell in accordance with one or more aspects of the present disclosure.

FIGS. 16 through 23 show flowcharts illustrating methods that support TCI activation in a candidate cell in accordance with one or more aspects of the present disclosure.

### DETAILED DESCRIPTION

Some wireless communications systems include multiple network entities that provide communication resources (e.g., serving cells) to a user equipment (UE). In some approaches, handover (or switching between serving cells) may be performed using layer 3 signaling. However, using layer 3 signaling for handover may result in relatively high handover latency. Alternatively, the UE may use layer 1 or layer 2 signaling to switch between serving cells to reduce latency. To switch from a source serving cell to a candidate serving cell, the UE may utilize a beam associated with the candidate serving cell. The beam to be used may be indicated by a transmission configuration indicator (TCI) state in the form of a quasi co-located (QCL'd) source reference signal. However, in layer 1 or layer 2-triggered mobility (LTM), the UE may receive a cell switch command but still lack at least some configuration information in order to successfully switch cells. One kind of information that may be lacking is an indication of a bandwidth part (BWP) to which an activated TCI state applies. A UE may also lack an indication of a BWP for the reference signal associated with the activated TCI state. For example, before switching between cells, the UE may have configuration information of the source serving cell and some limited configuration information of a candidate serving cell (e.g., reference signal information including synchronization signal block (SSB) information and TCI state information), but may lack BWP information of the candidate serving cell.

The described techniques relate to improved methods, systems, devices, and apparatuses that support TCI activation in a candidate cell. For example, the described techniques provide for indicating or determining one or more BWPs, indicating or determining one or more BWPs for one or more QCL'd source reference signals, indicating or determining activation of one or more TCI states, or indicating or determining one or more TCI state application times.

In some examples, a UE may receive, via a serving cell (e.g., a source serving cell), control information that is indicative of one or more BWPs for use in communications with a candidate serving cell (e.g., a target serving cell). The one or more BWPs may be associated with an activated TCI state of the candidate serving cell. The UE may receive control information that identifies a BWP of the candidate serving cell. For instance, the UE may receive an explicit indication of downlink or uplink BWP identifiers for a candidate cell (e.g., in a TCI activation medium access control-control element (MAC-CE) or in a cell switching MAC-CE). Alternatively, or in addition, the UE may determine the one or more BWPs based on a rule (e.g., an implicit rule) applied to the control information. For instance, the rule may indicate the BWP based on an association of a BWP with the activated TCI state. Or, the rule may indicate that the BWP includes one, some, or all BWPs within the bandwidth of the candidate serving cell when the control information lacks an indication of the BWP.

In some examples, a BWP for a QCL'd source reference signal of the activated TCI state of the candidate serving cell may be indicated, either explicitly or implicitly (by rule). For instance, the UE may receive, via a serving cell, a cell switch command indicating that the UE is to switch to a candidate cell via an LTM cell switching procedure. In order to determine which TCI state to use for the switch, the UE may determine whether the TCI activation information is received with the cell switch command or before the cell switch command.

In some examples, a UE may determine a TCI state application time. For example, the TCI state application time may indicate a time when the TCI state applied or when one or more beams associated with the TCI state are to be utilized for communication.

Aspects of the disclosure are initially described in the context of wireless communications systems. Aspects of BWP indication, BWP indication for QCL'd source reference signals, TCI state application time determination, and TCI state determination are described. Aspects of the disclosure are further illustrated by and described with reference to apparatus diagrams, system diagrams, and flowcharts that relate to TCI activation in a candidate cell.

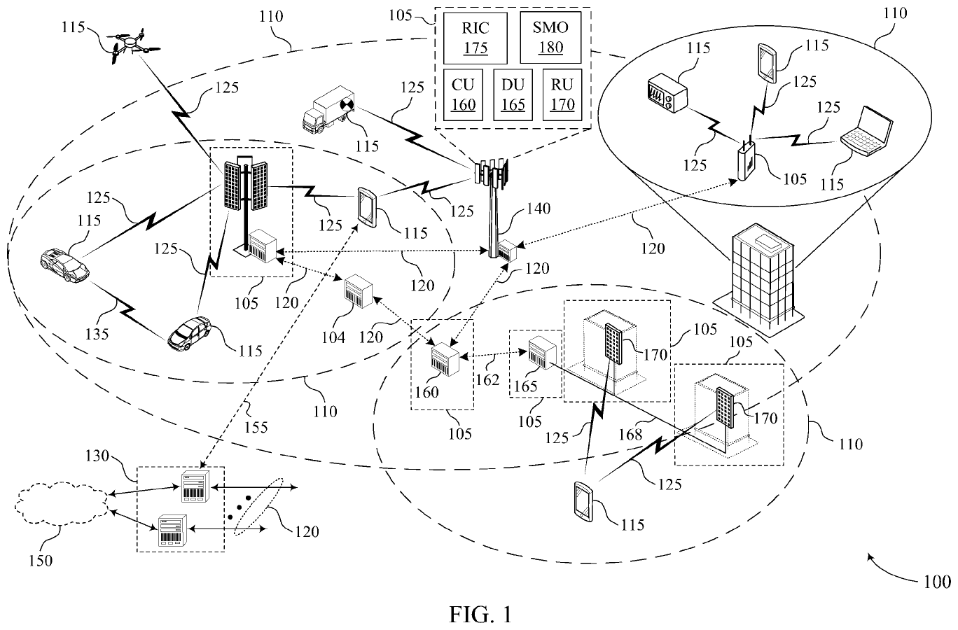

FIG. 1 shows an example of a wireless communications system 100 that supports TCI activation in a candidate cell in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein. Components within the wireless communication system 100 may be coupled (for example, operatively, communicatively, functionally, electronically, and/or electrically) to each other.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support TCI activation in a candidate cell as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA)), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of an RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Some wireless communications systems include multiple network entities that provide communication resources (e.g., serving cells) to a UE. In some approaches, handover (or switching between serving cells) may be performed using layer 3 signaling. However, using layer 3 signaling for handover may result in relatively high handover latency. Alternatively, the UE may use layer 1 or layer 2 signaling to switch between serving cells to reduce latency. To switch from a source serving cell to a candidate serving cell, the UE may utilize a beam associated with the candidate serving cell. The beam to be used may be indicated by a TCI state in the form of a QCL'd source reference signal. However, in layer 1 or layer 2-triggered mobility (LTM), the UE may receive a cell switch command but may still lack at least some configuration information in order to successfully switch cells. One kind of information that may be lacking is an indication of a BWP to which an activated TCI state applies. A UE may also lack an indication of a BWP for the reference signal associated with the activated TCI state. For example, before switching between cells, the UE may have configuration information of the source serving cell and some limited configuration information of a candidate serving cell (e.g., reference signal information including SSB information and TCI state information), but may lack BWP information of the candidate serving cell.

One or more LTM mechanisms or procedures may be utilized for mobility latency reduction. For example, configuration and maintenance for multiple candidate cells may allow for application of configurations for candidate cells. A dynamic switch mechanism may be utilized among candidate serving cells (including special cells (SpCell) and secondary cells (SCells), for example) for scenarios based on layer 1 or layer 2 signaling. For instance, an SpCell may be updated via layer 1 or layer 2 signaling based on a layer 1 measurement. Layer 1 enhancements may be utilized for inter-cell beam management, including layer 1 measurement and reporting, and beam indication. In some examples, timing advance management may be utilized. CU-DU interface signaling may be utilized to support layer 1 or layer 2 mobility. Frequency range 2 (FR2) specific enhancements may be utilized in some approaches.

In some examples, procedures for layer 1 or layer 2-based inter-cell mobility may be applicable to one or more of the following scenarios:
Standalone, carrier aggregation (CA), or new radio dual connectivity (NR-DC) cases (with a serving cell change within one cell group (CG), for example);
An intra-DU case and intra-CU inter-DU case (which may be applicable for standalone and CA cases with no new radio access network (RAN) interfaces, for example);
Intra-frequency or inter-frequency cases;
Frequency range 1 (FR1) or FR2 cases; or
Cases where source and target cells may be synchronized or non-synchronized.

The described techniques relate to improved methods, systems, devices, and apparatuses that support TCI activation in a candidate cell. For example, the described techniques provide for indicating or determining one or more BWPs, indicating or determining one or more BWPs for one or more QCL'd source reference signals, indicating or determining activation of one or more TCI states, or indicating or determining one or more TCI state application times.

In some examples, a UE 115 may receive, via a serving cell (e.g., a source serving cell), control information that is indicative of one or more BWPs for use in communications with a candidate serving cell (e.g., a target serving cell). The one or more BWPs may be associated with an activated TCI state of the candidate serving cell. The UE 115 may receive control information that identifies a BWP of the candidate serving cell. For instance, the UE 115 may receive an explicit indication of downlink or uplink BWP identifiers for a candidate cell (e.g., in a TCI activation medium access control-control element (MAC-CE) or in a cell switching MAC-CE). Alternatively, or in addition, the UE 115 may determine the one or more BWPs based at least in part on a rule (e.g., an implicit rule) applied to the control information. For instance, the rule may indicate the BWP based at least in part on an association of a BWP with the activated TCI state. Or, the rule may indicate that the BWP includes one, some, or all BWPs within the bandwidth of the candidate serving cell when the control information lacks an indication of the BWP.

In some examples, a BWP for a QCL'd source reference signal of the activated TCI state of the candidate serving cell may be indicated, either explicitly or implicitly (by rule). For instance, the UE 115 may receive, via a serving cell, a cell switch command indicating that the UE 115 is to switch to a candidate cell via an LTM cell switching procedure. In order to determine which TCI state to use for the switch, the UE 115 may determine whether the TCI activation information is received with the cell switch command or before the cell switch command.

In some examples, a UE 115 may determine a TCI state application time. The TCI state application time may indicate a time (e.g., a quantity of time from a cell switch command) when a TCI state is applied. For example, the TCI state application time may indicate a time when one or more beams associated with the TCI state are available (or are to be utilized) for communication.

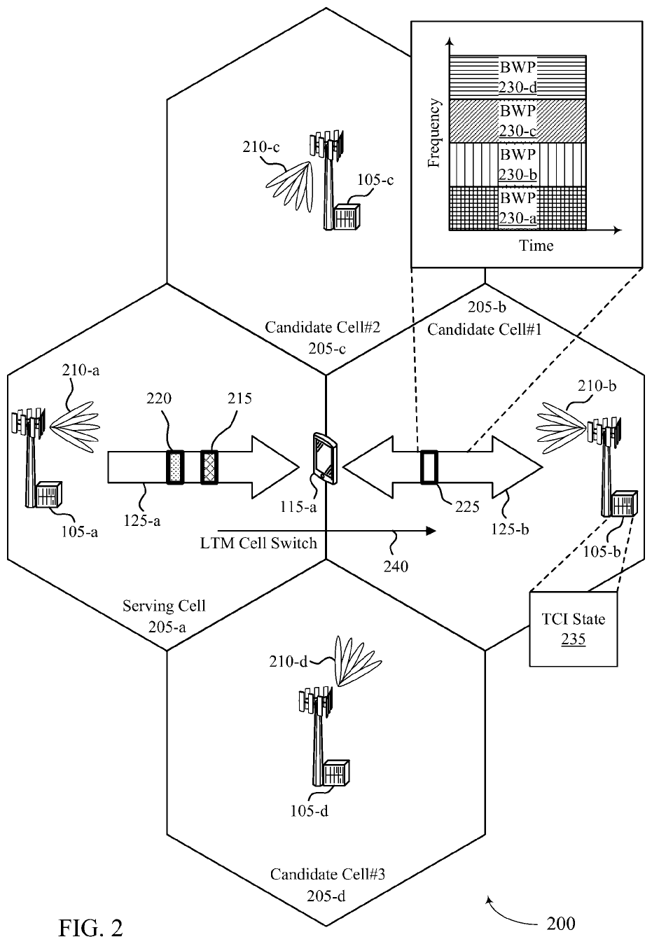

FIG. 2 shows an example of a wireless communication system 200 that supports TCI activation in a candidate cell in accordance with one or more aspects of the present disclosure. The wireless communications system 200 may implement aspects of or may be implemented by aspects of the wireless communications system 100. For example, the wireless communications system 200 includes a UE 115-a, which may be an example of a UE 115 described with respect to FIG. 1. The wireless communications system 200 also includes a network entity 105-a, a network entity 105-b, a network entity 105-c, and a network entity 105-d, which may be examples of a network entity 105 as described with respect to FIG. 1.

The UE 115-a may communicate with the network entity 105-a using a communication link. For example, the network entity 105-a may provide a serving cell 205-a for the UE 115-a. Network entity 105-b, network entity 105-c, and network entity 105-d may provide respective candidate cells 205-b, 205-c, 205-d. For use in examples described herein, the candidate cell 205-b may be referred to as Cell #1, candidate cell 205-c may be referred to as Cell #2, and candidate cell 205-d may be referred to as Cell #3. Each of the network entities 105-a, 105-b, 105-c, 105-d or cells 205-a, 205-b, 205-c, 205-d may provide one or more respective beams 210-a, 210-b, 210-c, 210-d for communication with the UE 115-a. As used herein, a “communication resource” may refer to a cell or beam. A “cell” may refer to a serving cell, a candidate cell, or a target cell. While one serving cell 205-a and three candidate cells 205-b, 205-c, 205-d are shown in the example of FIG. 2, a different quantity of serving cells or a different quantity of candidate cells may be utilized in some examples.

A candidate cell may be a cell that is a candidate for communication with a UE (e.g., UE 115-a). For example, a candidate cell may be a cell that may provide one or more communication resources to a UE (e.g., UE 115-a). A candidate cell may be evaluated by a UE (e.g., the UE 115-a) or a network entity (e.g., the network entity 105-a) for handover or cell switching of the UE. For example, one or more of the candidate cell 205-b, the candidate cell 205-c, or the candidate cell 205-d may be an LTM candidate cell or a non-serving cell. In a scenario, the serving cell 205-a may be a serving cell, and Cell #1, Cell #2, and Cell #3 may be non-serving cells that are candidate cells (e.g., candidate cells for handover or cell switching).

A target cell may be a cell (e.g., a candidate cell) that is selected for communication with a UE (e.g., UE 115-a). The term “candidate cell” may denote a candidate cell or a target cell (e.g., a candidate cell that has been selected for communication with a UE). In some examples, one or more candidate cells may be LTM candidate cells (which may be serving cells or non-serving cells), may be a single serving cell, or may be multiple serving cells.

In some examples, a cell may be a primary cell (PCell), SCell, or SpCell. For example, the serving cell 205-a and the candidate cells 205-b, 205-c, 205-d may be SpCells included in a configured candidate SpCell set.

The UE 115-a may establish one or more communication links with one or more of the network entities 105-a, 105-b, 105-c, 105-d. In some examples, a communication link may be an example of an NR or LTE link between the UE 115-a and a network entity 105-a, network entity 105-b, network entity 105-c, or network entity 105-d. The communication link may include bi-directional links that enable both uplink and downlink communications. For example, the UE 115-a may transmit uplink signals (e.g., uplink transmissions), such as uplink control signals or uplink data signals, to one or more of network entity 105-a, network entity 105-b, network entity 105-c, or network entity 105-d. One or more of network entity 105-a, network entity 105-b, network entity 105-c, or network entity 105-d may transmit downlink signals (e.g., downlink transmissions), such as downlink control signals or downlink data signals, to the UE 115-a using a communication link. In the example of FIG. 2, a first communication link 125-a between the network entity 105-a and the UE 115-a is shown. A second communication link 125-b between the network entity 105-b and the UE 115-a is also shown.

The example of FIG. 2 illustrates an example of an LTM cell switch 240 from the serving cell 205-a to the candidate cell 205-b. The LTM cell switch 240 may occur in one or more scenarios, including a single SpCell change without CA (e.g., standalone), CA, or NR-DC, among other examples. The UE 115-a may utilize information to switch communications from the serving cell 205-a to the candidate cell 205-b. Information that may be utilized for the LTM cell switch 240 may include TCI state information, BWP information, QCL information, reference signal information, beam information, or a combination thereof, relative to the candidate cell 205-b. For example, TCI state information may indicate one or more TCI states 235 (e.g., activated TCI states) of the candidate cell 205-b. BWP information (e.g., one or more BWPs) may indicate frequency resource information for communication with the candidate cell 205-b. QCL information may indicate one or more QCL relationships of one or more TCI states with one or more source reference signals associated with the candidate cell 205-b. Reference signal information may indicate one or more types of reference signals (e.g., channel state information-reference signal (CSI-RS) or SSB, among other examples) associated with the candidate cell 205-b. Beam information may indicate one or more beams 210-b for communication. In some examples, TCI state information may indicate (e.g., may include) BWP information, QCL information, reference signal information, beam information, or one or more combinations thereof. In some examples, TCI state information may omit BWP information, QCL information, reference signal information, beam information, or one or more combinations thereof. In some examples, network entity 105-b may indicate TCI state information (e.g., TCI state 235) to network entity 105-a via signaling (e.g., backhaul signaling).

The UE 115-a may receive, via the serving cell 205-a, control information 215 that is indicative of one or more BWPs (e.g., one or more of BWP 230-a, BWP 230-b, BWP 230-c, or BWP 230-d). The one or more BWPs may be associated with an activated TCI state 235 of the candidate cell 205-b. For example, the one or more BWPs (e.g., BWP identifier(s)) may be indicated in the TCI state 235. In some examples, the control information 215 may be communicated (e.g., transmitted or received) via an RRC message or a MAC-CE. While four BWPs 230-a, 230-b, 230-c, 230-d are shown in FIG. 1, a different quantity of BWPs may be utilized in some examples.

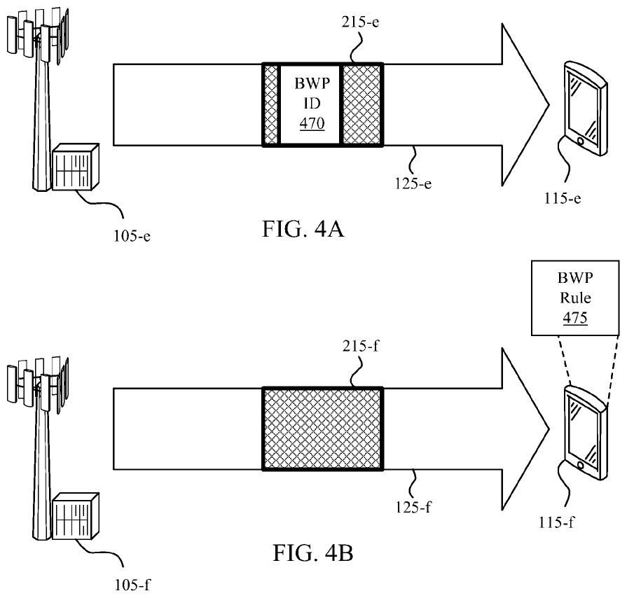

In some approaches (e.g., in LTM), the UE 115-a may determine a downlink or uplink BWP for one or more activated TCI states (e.g., TCI state 235) in candidate cell 205-b based at least in part on an explicit indication or based at least in part on a rule (e.g., implicit rule). For instance, the serving cell 205-a may provide an explicit indication of one or more applied downlink or uplink BWP identifiers in candidate cell 205-b. In some examples, the one or more BWPs may be indicated by inclusion, in the control information, of one or more BWP identifiers of candidate cell 205-b. An example of one or more BWP identifiers being included in control information is illustrated in FIG. 4A. The control information may be received via a TCI activation MAC-CE or via a cell switch MAC-CE.

In some approaches, association of the one or more BWPs with the activated TCI state 235 is via a rule applied to the control information. For example, the rule may be instructions, logic, one or more conditions, one or more criteria, one or more mappings (e.g., look-up table), or one or more functions to determine the one or more BWPs based at least in part on the control information. In some examples, the rule may be utilized for an implicit indication of the one or more BWPs. For instance, the control information may not include an explicit indication of the one or more BWPs. The UE 115-a may utilize (e.g., execute, follow) the rule to determine the one or more BWPs based at least in part on the control information. An example of one or more BWPs being implicitly indicated via a rule is illustrated in FIG. 4B.

In some approaches, the control information may be received via an RRC configuration message. In some examples, the rule may indicate that the one or more BWPs include one or more first active BWPs configured via the RRC configuration message. For instance, the rule may indicate that one or more first active uplink or downlink BWPs (e.g., an active BWP(s) with a lowest or lower index(es) or an active BWP(s) that is first or earlier in an order), which are RRC configured for the candidate cell 205-b, are associated with the activated TCI state 235. In some examples, the rule may indicate that the one or more BWPs include an initial BWP configured via the RRC configuration message. For instance, the rule may indicate that one or more initial BWPs (e.g., an initially active BWP(s), a BWP(s) that has been active for a longer or longest period), which are RRC configured for the candidate cell 205-b, are associated with the activated TCI state 235. In some examples, the rule may be utilized to indicate or determine one or more BWPs for another purpose (in addition to or alternatively from an association with the activated TCI state).

In some examples, the control information may be an indication of the activated TCI state and may be received separate from candidate cell configuration signaling and serving cell configuration signaling. For instance, a TCI state 235 may be configured outside of the candidate cell 205-b configuration signaling and outside of the serving cell 205-a configuration signaling and may lack an indication of, or an association with, a BWP. In some examples, the control information may lack an indication of the one or more BWPs. The rule may indicate that, based at least in part on lack of the indication of the one or more BWPs in the control information, the one or more BWPs may include one or more BWPs within a bandwidth of the candidate cell 205-b. For example, in a case that the control information lacks an indication of a BWP (e.g., no BWP is indicated for the (pre-activated) TCI state 235, the TCI state 235 may be utilized for any BWP after cell switching.

In some approaches (e.g., in LTM), the UE 115-a may determine a downlink or uplink BWP for a QCL'd source reference signal (e.g., a source reference signal providing QCL information) in one or more activated TCI states (e.g., TCI state 235) for candidate cell 205-b based at least in part on an explicit indication or based at least in part on a rule (e.g., implicit rule). In some examples, the serving cell 205-a may provide an explicit indication of one or more downlink or uplink BWP identifiers for a QCL'd source reference signal in a TCI state 235 via RRC configuration. For instance, The QCL'd source reference signal may be configured as a CSI-RS for beam management, which may have a downlink BWP that is RRC configured. In some examples, one or more BWPs may be indicated by inclusion, in the control information, of a BWP identifier for a QCL'd source reference signal of the activated TCI state 235 of the candidate cell 205-b. The control information may be received via an RRC configuration message.

In some approaches, association of the one or more BWPs with a QCL'd source reference signal of the activated TCI state may be via a rule (e.g., a QCL rule) applied to the control information. The rule for BWP determination for the QCL'd source reference signal may be similar to, or different from, the rule for BWP determination described herein. For example, the rule (e.g., QCL rule) may be instructions, logic, one or more conditions, one or more criteria, one or more mappings (e.g., look-up table), or one or more functions to determine the one or more BWPs for a QCL'd source reference signal based at least in part on the control information. In some examples, the rule may be utilized for an implicit indication of the one or more BWPs for one or more QCL'd source reference signals. For instance, the control information may not include an explicit indication of the one or more BWPs for one or more QCL'd source reference signals. The UE 115-a may utilize (e.g., execute, follow) the rule (e.g., QCL rule) to determine the one or more BWPs for the one or more QCL'd source reference signals based at least in part on the control information.

In some approaches, the control information may be received via an RRC configuration message. In some examples, the rule may indicate that the one or more BWPs, associated with the QCL'd source reference signal, include a first active BWP configured via the RRC configuration message. For instance, the rule (e.g., QCL rule) may indicate that one or more first active uplink or downlink BWPs (e.g., an active BWP(s) with a lowest or lower index(es) or an active BWP(s) that is first or earlier in an order) for one or more QCL'd source reference signals, are associated with the activated TCI state 235, where the one or more first active BWPs are RRC configured for the candidate cell 205-b. In some examples, the rule may indicate that the one or more BWPs, associated with the one or more QCL'd source reference signals, include an initial BWP configured via the RRC configuration message. For instance, the rule may indicate that one or more initial BWPs (e.g., an initially active BWP(s), a BWP(s) that has been active for a longer or longest period), are associated with the activated TCI state 235, where the one or more initial BWPs are RRC configured for the candidate cell 205-b.

In some examples, the control information may be an indication of the activated TCI state and may be received separate from candidate cell configuration signaling and serving cell configuration signaling. For instance, a TCI state 235 may be configured outside of the candidate cell 205-b configuration signaling and outside of the serving cell 205-a configuration signaling and may lack an indication of, or an association with, a BWP. In some examples, the control information may lack an indication of the one or more BWPs. The rule may indicate that, based at least in part on lack of the indication of the one or more BWPs in the control information, the one or more BWPs may include one or more BWPs, for the QCL'd reference signal, within a bandwidth of the candidate cell 205-b. For example, in a case that the control information lacks an indication of a BWP for the QCL'd source reference signal (e.g., no BWP is indicated for the (pre-activated) TCI state 235), the QCL'd source reference signal may be utilized for any BWP after cell switching. In some examples, the QCL'd source reference signal may be configured as a CSI-RS for mobility (e.g., used for mobility), the QCL'd source reference signal may be configured as a CSI-RS with an associated frequency allocation (but no BWP, for instance), or the QCL'd source reference signal may be configured as an SSB with an associated frequency allocation (but no BWP, for instance).

The UE 115-a may receive, via the serving cell 205-a, a cell switch command 220 that indicates for the UE 115-a to switch (e.g., indicates, commands, instructs, or requests the UE 115-a to switch) to the candidate cell 205-b via an LTM cell switching procedure. For instance, the UE 115-a may receive a MAC-CE including the cell switch command 220. In some examples, the control information 215 and the switch command 220 may be communicated (e.g., transmitted or received) in a same message or in different (e.g., separate) messages. The UE 115-a may perform (e.g., execute) the LTM cell switching procedure in response to the cell switch command 220.

The UE 115-a may communicate one or more messages 225 with the candidate cell 205-b in accordance with the cell switch command 220 and the activated TCI state 235 using the one or more BWPs (e.g., one or more of the BWP 230-a, the BWP 230-b, the BWP 230-c, or the BWP 230-d) of the candidate cell 205-b.

In some approaches, the UE 115-a may support multiple active TCI states per candidate cell (e.g., the candidate cell 205-b, the candidate cell 205-c, or the candidate cell 205-d). In a first example, the UE 115-a may be configured with joint TCI state activation information and a cell switch command (e.g., beam indication) of the candidate cell 205-b in single MAC-CE message. For instance, the UE 115-a may receive TCI state activation information in (e.g., jointly with) the cell switch command 220 (without separate TCI activation signaling, for example). In a second example, the UE 115-a may be configured with separate TCI state activation information and a cell switch command (e.g., beam indication) of the candidate cell 205-b in different MAC-CE messages. For instance, the UE 115-a may receive TCI activation information to activate multiple TCI states, where one TCI state may be selected in the cell switching command 220.

In some examples, the UE 115-a may support a single active TCI state per candidate cell (e.g., per the candidate cell 205-b, the candidate cell 205-c, and the candidate cell 205-d). The UE 115-a may be configured with joint TCI state activation information and cell switch (e.g., TCI state indication or beam indication) of the candidate cell 205-b in the same MAC-CE message. In this case, the TCI state (e.g., beam) indicated in the cell switch command 220 may be used for reception of one or more (e.g., all) channels. The one or more channels may include dedicated and non-dedicated physical downlink control channel (PDCCH) or physical downlink shared channel (PDSCH) for downlink and physical uplink shared channel (PUSCH) or physical uplink control channel (PUCCH) for uplink on the candidate cell 205-b (e.g., target cell) before a new TCI state is activated or indicated. In some examples, whether the TCI state activation information and cell switch command 220 are received jointly or separately may be utilized for TCI state indication (e.g., beam indication) in LTM.

In some examples, the serving cell 205-a may send, and the UE 115-a may receive, activation information (not shown in FIG. 2). For instance, the UE 115-a may receive, via the serving cell 205-a, activation information that is indicative of activation of one or more TCI states of the candidate cell 205-b. The activation information may be communicated in the control information 215 or may be communicated separately from the control information 215. The activation information may indicate, for example, activation of one or more TCI states, which may indicate one or more resources (e.g., one or more BWPs, beams, or QCL'd source reference signals, among other examples).

In some examples, the UE 115-a may receive, via the serving cell 205-a, the cell switch command 220 for the UE 115-a to switch to the candidate cell 205-b via an LTM cell switching procedure, where a determination of a TCI state (e.g., indication of the TCI state 235) of one or more TCI states may be based at least in part on whether the activation information is received with the cell switch command 220 or before the cell switch command 220. For instance, the UE 115-a may determine a TCI state from multiple TCI states based at least in part on whether the activation information is received with the cell switch command 220 or before the cell switch command 220. The UE 115-a may communicate with the candidate cell 205-b in accordance with the cell switch command 220 and the TCI state. For example, the UE 115-a may communicate on one or more channels with the candidate cell 205-b in accordance with the TCI state and a beam indicated via the cell switch command 220.

The cell switch command 220 may include a beam indication (not shown in FIG. 2) in some examples. The beam indication may be information indicative of one or more beams 210-b of the candidate cell 205-b. For example, the UE 115-a may receive the beam indication with the cell switch command 220. In some examples, the activation information, the cell switch command 220, and a beam indication may be received via a MAC-CE.

In some examples, the beam indication may be communicated (e.g., transmitted or received) separately from the cell switch command 220. For instance, the activation information and a beam indication may be received via at least one first MAC-CE message before the cell switch command, and the cell switch command may be received via at least one second MAC-CE message.

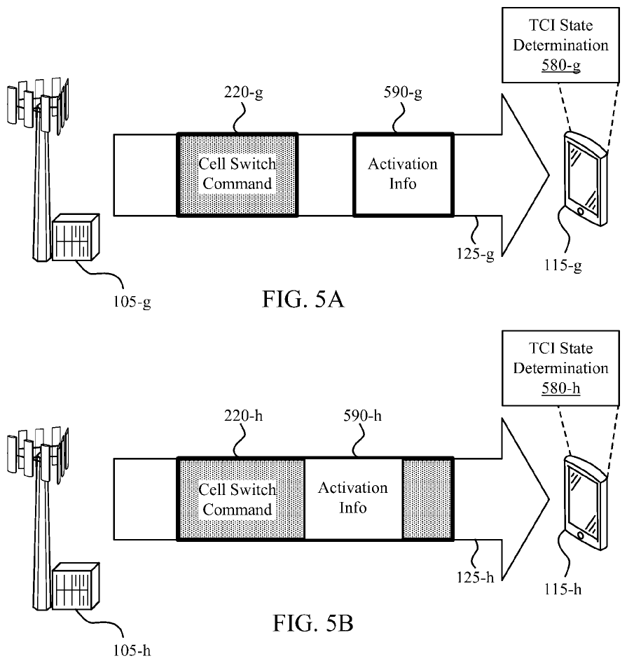

As described herein, activation information may be received before the cell switch command 220 in some examples. An example of activation information being received before the cell switch command is given in FIG. 5A. In some examples, the UE 115-a may determine the TCI state based at least in part on a TCI codepoint index received via the cell switch command 220 when the activation information is received before the cell switch command 220. The communication with the candidate cell 205-b may be performed with one or more transmission and reception points (TRPs).

For single TRP operation or single downlink control information (DCI) and multiple TRP operation in the candidate cell 205-b, for example, a TCI codepoint index to indicate an activated TCI codepoint included in the cell switch command 220 may be communicated to enable the UE 115-a to determine the TCI state(s) of the candidate cell 205-b (e.g., target cell). For instance, activation information (e.g., TCI activation signaling) to activate multiple TCI codepoints may be sent to the UE 115-a. One TCI codepoint may then be selected (from the multiple activated TCI codepoints) based at least in part on the TCI codepoint index indicated in the cell switch command 220.

In some approaches for multiple TRP operation, one TCI codepoint index may be mapped to up to 2 TCI states. In some examples, up to 128 TCI states may be configured by RRC signaling and up to 8 TCI codepoints may be activated by TCI activation information. If a TCI codepoint index is not present in the cell switch command 220, the TCI codepoint of the lowest index, for example, may be applied for the candidate cell 205-b (e.g., target cell).

In some examples, the UE 115-a may determine the TCI state 235 based at least in part on one or more TCI codepoint indexes associated with different control resource set (CORESET) indexes. For instance, for multiple DCI and multiple TRP operation in the candidate cell 205-b, two TCI codepoint indexes of different CORESET pool indexes to indicate two activated TCI codepoints included in the cell switch command may be provided to determine the TCI states of the candidate cell 205-b (e.g., target cell). The one or more TCI codepoint indexes may be received via the cell switch command 220 when the activation information is received before the cell switch command. The communication with the candidate cell 205-b may be performed with one or more TRPs.

In some scenarios, the TCI activation information may by indicated together with the cell switch command 220. An example of activation information being indicated with the cell switch command is given in FIG. 5B. In some examples, the UE 115-a may determine the TCI state based at least in part on a TCI state index received via the cell switch command 220 when the activation information is received with the cell switch command 220. The communication with the candidate cell 205-b may be performed with a TRP. For single TRP operation, for example, a TCI state index may be included in the cell switch command to determine the TCI state 235 of the candidate cell 205-b (e.g., target cell).

In some examples, the UE 115-a may determine the TCI state based at least in part on one or more TCI state indexes received via the cell switch command 220 when the activation information is received with the cell switch command 220. The communication with the candidate cell 205-b may be performed with a plurality of TRPs. For multiple TRP operation in the candidate cell 205-b operation, for instance, two TCI state indexes may be included in the cell switch command 220 to determine the TCI states of the candidate cell 205-b (e.g., target cell). In some examples, if a TCI index is not sent or received (e.g., no TCI activation or TCI indication (no beam indication) are provided), the UE 115-a may trigger a contention-based random access (CBRA) procedure for the candidate cell 205-b (e.g., target cell).

To switch to the candidate cell 205-b via the LTM cell switching procedure, the UE 115-a may utilize a TCI state application time. The TCI state application time may provide a period to allow the UE 115-a to perform one or more switching operations to switch from the serving cell 205-a to the candidate cell 205-b. In some examples, the UE 115-a may be configured to utilize multiple TCI states or multiple beams for multiple target cells. Each TCI state may have an associated TCI state application time or each beam may have an associated beam application time. The description herein regarding TCI state application times may additionally or alternatively refer to beam application times. When a MAC-CE includes activation information for multiple TCI states (or when the beam indication indicates multiple beams) for multiple target cells (e.g., multiple of the candidate cell 205-b, the candidate cell 205-c, or the candidate cell 205-d), the UE 115-a may determine one or more application times (e.g., TCI state activation times or beam application times) to utilize in an LTM cell switch procedure.

In some examples, the activated TCI state 235 may be one of multiple activated TCI states for corresponding multiple candidate cells (e.g., of candidate cell 205-b, candidate cell 205-c, or candidate cell 205-d). The UE 115-a may determine a TCI state application time as a maximum TCI state application time among multiple TCI state application times respectively associated with the multiple activated TCI states and with multiple target cells (e.g., of candidate cell 205-b, candidate cell 205-c, or candidate cell 205-d). For instance, the UE 115-a may determine a maximum TCI state application time (e.g., beam application time) among the TCI state application times (e.g., beam application times) for each target cell (e.g., based on a minimum subcarrier spacing (SCS)). Communication with the candidate cell 205-b may include communicating via one or more beams in accordance with the TCI state application time.

In some examples, the activated TCI state 235 may be one of multiple activated TCI states for corresponding multiple candidate cells (e.g., of candidate cell 205-b, candidate cell 205-c, or candidate cell 205-d). The UE 115-a may determine a TCI state application time as a sum of multiple TCI state application times respectively associated with the multiple activated TCI states and with multiple target cells (e.g., of candidate cell 205-b, candidate cell 205-c, or candidate cell 205-d). For instance, the UE 115-a may determine a sum of the TCI state application times (e.g., beam application times) for each target cell. Communication with the candidate cell 205-b may include communicating via one or more beams in accordance with the TCI state application time.

In some examples, the UE 115-a may determine a TCI state application time, an RRC application time, or an RF tuning time based at least in part on a quantity of target cells. The TCI state application time, the RRC application time, or the RF tuning time may increase with an increasing quantity of target cells. For instance, the TCI state application time (e.g., a separate beam application time) may increase with the quantity of target cells. A time value (e.g., a quantity of milliseconds, a variable time amount) for switching to one target cell may scale with the quantity of target cells (e.g., one time value for switching to one target cell, two time values for switching to two target cells). In some examples, one or more time values may be utilized. For instance, a time value may be set for a TCI state application time per quantity of target cells, a time value may be set for an RRC application per quantity of target cells, or a time value may be set for RF tuning time per quantity of cells. Additional time values may be utilized for multiple target cells. Communication with the candidate cell 205-b may include communicating in accordance with the TCI state application time, the RRC application time, or the RF tuning time.

In some examples, the UE 115-a may determine a respective TCI state application time for each of multiple target cells. For instance, the UE 115-a may utilize a separate TCI state application time (e.g., beam application time) for each target cell. Communication with the candidate cell (e.g., the target cell) may include communicating via multiple beams in accordance with the respective TCI state application time for each of the multiple target cells.

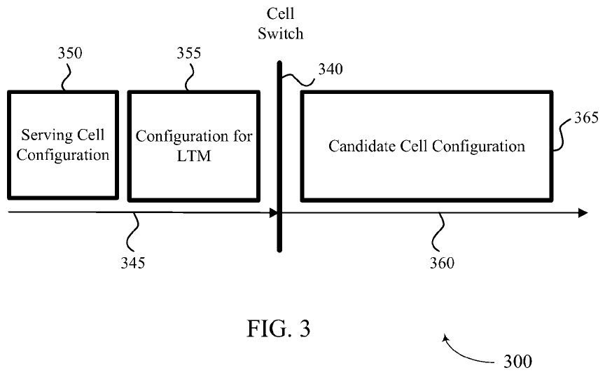

FIG. 3 shows an example of a timeline 300 for a cell switch 340. In this example, the timeline 300 includes a pre-switch period 345, a cell switch 340, and a post-switch period 360. In some approaches, a UE may receive a serving cell configuration 350 in the pre-switch period 345. The serving cell configuration 350 may be RRC configured and available before the cell switch 340. The serving cell configuration 350 may provide the UE with information (e.g., one or more TCI states, one or more reference signals, one or more BWPs) to communicate with a serving cell (e.g., source cell).

In some approaches, before the cell switch 340 in the pre-switch period 345, the UE may receive a configuration for LTM 355 from the serving cell. The configuration for LTM 355 may be RRC configured and available before the cell switch 340. The configuration for LTM 355 may provide the UE with limited information regarding a candidate cell. For instance, the configuration for LTM 355 may provide some limited TCI state or reference signal information corresponding to the candidate cell. However, the configuration for LTM 355 may lack information (e.g., BWP information, beam information, or additional reference signal information, among other examples) regarding the candidate cell. In some approaches, the UE may perform a cell switch 340 and may receive a candidate cell configuration 365 (e.g., reference signal configuration or BWP configuration) after the cell switch 340 in the post-switch period 360. The candidate cell configuration 365 may be RRC configured and available after the cell switch 340. However, this approach may result in increased latency for switching cells.

Some examples of the methods, systems, and devices described herein may provide additional information (e.g., additional TCI state information, reference signal information, or BWP information, among other examples) to the UE during the pre-switch period 345. For example, the UE may receive signaling indicative of one or more TCI states, BWPs, BWPs for QCL'd source reference signals, or application times before the cell switch 340 as described with respect to FIG. 2. For instance, the UE may receive information indicative of one or more BWPs for which the TCI state is configured or indicative of one or more BWPs for a QCL'd source reference signal for which the TCI state is configured. The additional information may result in reduced latency for the cell switch in LTM.

FIG. 4A shows an example of a BWP identifier 470 included in control information 215-e that supports TCI activation in a candidate cell in accordance with one or more aspects of the present disclosure. In the example of FIG. 4A, a network entity 105-e utilizes a communication link 125-e to communicate with a UE 115-e. The network entity 105-e, the communication link 125-e, and the UE 115-e may be examples of corresponding elements as described with respect to FIG. 1 or FIG. 2.

In the example of FIG. 4A, the network entity 105-e sends control information 215-e to the UE 115-e via the communication link 125-e. The control information 215-e may be an example of the control information 215 described with respect to FIG. 2. The control information 215-e includes a BWP identifier 470. For example, the BWP identifier 470 is an explicit indication of one or more BWPs associated with a TCI state of a candidate cell. The BWP identifier 470 may include numeric or symbolic content explicitly indicating the one or more BWPs. The UE 115-e may receive the BWP identifier 470 and may use the BWP identifier 470 to determine the one or more BWPs to utilize in an LTM cell switching procedure.

FIG. 4B shows an example of a BWP rule 475 that supports TCI activation in a candidate cell in accordance with one or more aspects of the present disclosure. In the example of FIG. 4B, a network entity 105-f utilizes a communication link 125-f to communicate with a UE 115-f. The network entity 105-f, the communication link 125-f, and the UE 115-f may be examples of corresponding elements as described with respect to FIG. 1 or FIG. 2.

In the example of FIG. 4B, the network entity 105-f sends control information 215-f to the UE 115-f via the communication link 125-f. The control information 215-f may be an example of the control information 215 described with respect to FIG. 2. The control information 215-f is indicative of one or more BWPs. For example, association of one or more BWPs with an activated TCI state of a candidate cell is via the BWP rule 475 applied to the control information 215-f. In the example of FIG. 4B, the control information 215-f provides an implicit indication of one or more BWPs associated with a TCI state of a candidate cell. For instance, the BWP rule 475 may indicate that the one or more BWPs of the candidate cell include a first active BWP or an initial BWP configured via the control information 215-f (e.g., control information in an RRC message). In some examples, the BWP rule may indicate, based at least in part on a lack of indication of the one or more BWPs in the control information 215-f, that the one or more BWPs include multiple (e.g., all) BWPs within a bandwidth of the candidate cell.

FIG. 5A shows an example of activation information 590-g and a cell switch command 220-g that support TCI activation in a candidate cell in accordance with one or more aspects of the present disclosure. In the example of FIG. 5A, a network entity 105-g utilizes a communication link 125-g to communicate with a UE 115-g. The network entity 105-g, the communication link 125-g, and the UE 115-g may be examples of corresponding elements as described with respect to FIG. 1 or FIG. 2.

In the example of FIG. 5A, the network entity 105-g sends activation information 590-g before a cell switch command 220-g to the UE 115-g via the communication link 125-g. The cell switch command 220-g may be an example of the cell switch command 220 described with respect to FIG. 2. In some examples, a determination 580-g of a TCI state (from multiple TCI states) may be based at least in part on whether activation information is received with a cell switch command or before a cell switch command. In the example of FIG. 5A, the activation information 590-g is received before the cell switch command 220-g. The activation information 590-g indicates activation of multiple TCI states corresponding to a candidate cell. The cell switch command 220-g may include one or more TCI codepoint indexes indicating one or more of the activated TCI states as described with respect to FIG. 2. The UE 115-g may perform the determination 580-g to determine the one or more TCI states from the activated TCI states. The UE 115-g may utilize the one or more TCI states in an LTM cell switching procedure.

FIG. 5B shows an example of activation information 590-h and a cell switch command 220-h that support TCI activation in a candidate cell in accordance with one or more aspects of the present disclosure. In the example of FIG. 5B, a network entity 105-h utilizes a communication link 125-h to communicate with a UE 115-h. The network entity 105-h, the communication link 125-h, and the UE 115-h may be examples of corresponding elements as described with respect to FIG. 1 or FIG. 2.

In the example of FIG. 5B, the network entity 105-h sends activation information 590-h via a cell switch command 220-h to the UE 115-h via the communication link 125-h. The cell switch command 220-h may be an example of the cell switch command 220 described with respect to FIG. 2. In some examples, a determination 580-h of a TCI state (from multiple TCI states) may be based at least in part on whether activation information is received via a cell switch command or before a cell switch command. In the example of FIG. 5B, the activation information 590-h is received with the cell switch command 220-h. The cell switch command 220-h may a TCI state index indicating one or more of the activated TCI states as described with respect to FIG. 2. The UE 115-h may perform the determination 580-h to determine the one or more TCI states based at least in part on the TCI state index. The UE 115-h may utilize the one or more TCI states in an LTM cell switching procedure.

Some examples of TCI state information may include unified TCI types. Type 1 may be a joint TCI state to indicate a common beam for at least one downlink channel or reference signal an at least one uplink channel or reference signal. For example, Type 1 may indicate a UE-specific PDCCH, PDSCH, PUCCH, PUSCH, or CSI-RS. Type 2 may indicate a downlink TCI state to indicate a common beam for more than one downlink channel or reference signal. Type 2 may indicate a UE-specific PDCCH, PDSCH, or CSI-RS. Type 3 may indicate an uplink TCI state to indicate a common beam for more than one uplink channel or reference signal. Type 3 may indicate a UE-specific PUCCH or PUSCH.

In some approaches, unified TCI-based beam indication may be supported. In a first approach, TCI state activation (e.g., activation information 590-g) of a candidate cell may be received before the reception of a beam indication of the candidate cell (via the cell switch command 220-g, for example). In a second approach, TCI state activation (e.g., activation information 590-h) of a candidate cell may be received together with the reception of a beam indication of the candidate cell (via the cell switch command 220-g, for instance). For example, beam indication and activation may be performed via a single joint TCI state or a pair of uplink and downlink TCI states in a cell switch command. Signaling may be provided for TCI state indication when both activation and indication are performed via the same MAC-CE message carrying the switch command. In a third approach, one or more of the first approach and the second approach may be supported based at least in part on a UE capability. For instance, a UE may signal a capability to perform the first approach or the second approach. A network entity may determine whether to utilize the first approach or the second approach based on the UE capability. In some examples where the first approach and the third approach are supported, other beam indication or TCI activation timing relationships may not be precluded.

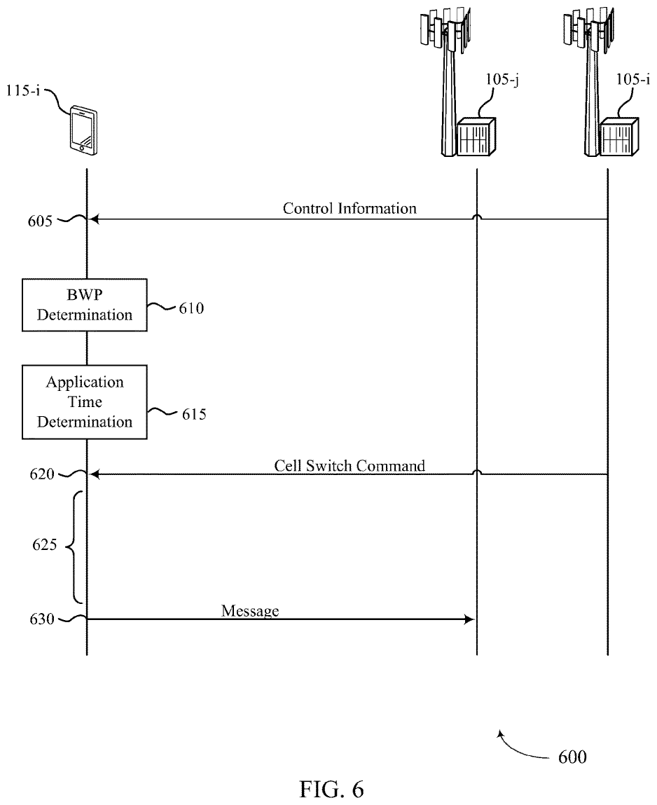

FIG. 6 shows an example of a process flow 600 that supports TCI activation in a candidate cell in accordance with one or more aspects of the present disclosure. The process flow 700 may include a UE 115-i, which may be an example of UEs 115, as described herein with reference to FIG. 1 or FIG. 2. The process flow 700 may also include a network entity 105-i and a network entity 105-j, which may be examples of the network entities 105, as described herein. The network entity 105-i may provide a serving cell and the network entity 105-j may provide a candidate cell for an LTM cell switching procedure.

In the following description of the process flow 700, the operations between the network entity 105-i, the network entity 105-j, and the UE 115-i may be performed in a different order than the example order shown, or the operations performed by the network entity 105-i, the network entity 105-j, and the UE 115-i may be performed in different orders or at different times. Some operations may also be omitted from the process flow 700, and other operations may be added to the process flow 700.

In some aspects, at 605, the UE 115-i may receive, from the network entity 105-i, control information. The control information may be indicative of one or more BWPs associated with an activated TCI indicator state of a candidate cell as described with respect to FIG. 2, FIG. 4A, or FIG. 4B.

In some aspects, at 610, the UE 115-i may perform a BWP determination. For example, the UE 115-i may utilize the control information to determine one or more BWPs. For instance, the UE 115-i may read an explicit BWP indication from the control information or may determine the one or more BWPs via a rule applied to the control information.

In some aspects, at 615, the UE 115-i may perform a TCI state application time determination. The TCI state application time determination may be performed as described with respect to FIG. 2. For instance, the UE 115-i may determine a TCI state application time as a maximum TCI state application time from multiple TCI state application times corresponding to multiple target cells, as a sum of TCI state application times corresponding to multiple target cell, or based at least in part on TCI state application time that increases with a quantity of target cells, among other examples.

In some aspects, at 620, the UE 115-i may receive a cell switch command from the network entity 105-i. For example, the UE 115-i may receive a cell switch command as described with respect to FIG. 2.

In some aspects, at 625, the UE 115-i may utilize the TCI state application time. A TCI state application time may be a period to allow the UE 115-i to perform a cell switching procedure (e.g., LTM cell switching procedure). For example, the TCI state application time may be a period in which the UE 115-i performs one or more operations (e.g., beam application or RF retuning for an inter-frequency switch, among other examples). In some approaches, the TCI state application time may start after the last symbol of a PUCCH or PUSCH carrying hybrid automatic repeat request acknowledgment (HARQ-ACK) for the PDSCH that carries a MAC-CE including a cell switch command with a beam indication for one or more target cells. In some examples, the TCI state application time may be based on a value

$$3 {N}_{slot}^{subframe , μ} ,$$

based on whether TCI state activation information is received before or together with a cell switch command, or based on whether the target cell is a current serving cell.

In some aspects, at 630, the UE 115-i may transmit a message to the network entity 105-j. For example, the UE 115-i may utilize the one or more determined BWPs to send the message to the network entity 105-j.

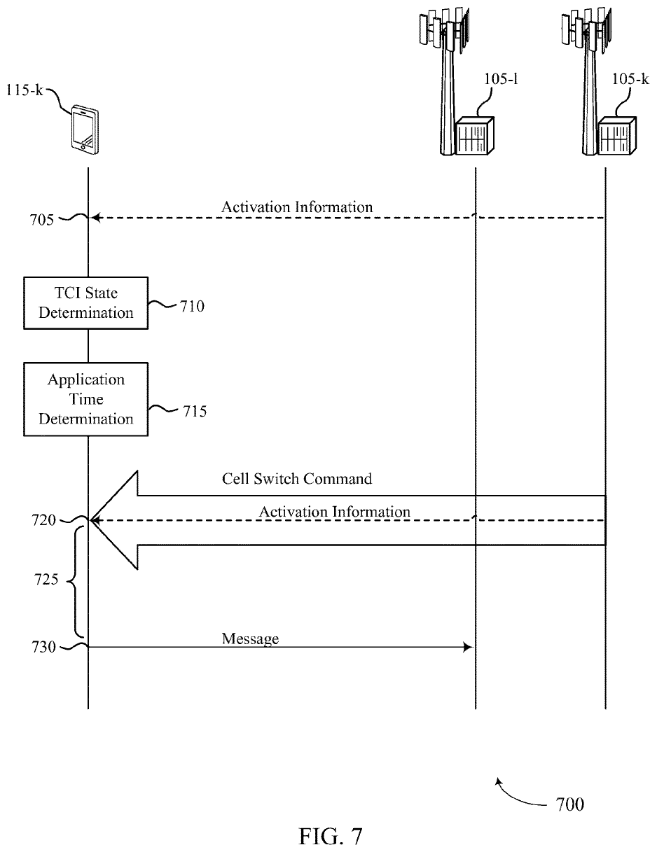

FIG. 7 shows an example of a process flow 700 that supports TCI activation in a candidate cell in accordance with one or more aspects of the present disclosure. The process flow 700 may include a UE 115-k, which may be an example of UEs 115, as described herein with reference to FIG. 1 or FIG. 2. The process flow 700 may also include a network entity 105-k and a network entity 105-l, which may be examples of the network entities 105, as described herein. The network entity 105-k may provide a serving cell and the network entity 105-l may provide a candidate cell for an LTM cell switching procedure.

In the following description of the process flow 700, the operations between the network entity 105-k, the network entity 105-l, and the UE 115-k may be performed in a different order than the example order shown, or the operations performed by the network entity 105-k, the network entity 105-l, and the UE 115-k may be performed in different orders or at different times. Some operations may also be omitted from the process flow 700, and other operations may be added to the process flow 700.

In some aspects, at 705, the UE 115-k may optionally receive, from the network entity 105-k, activation information. In some aspects, at 720 the activation information may be optionally received via a cell switch command. The activation information may be indicative of a TCI indicator state of a candidate cell as described with respect to FIG. 2, FIG. 5A, or FIG. 5B.

In some aspects, at 710, the UE 115-k may perform a TCI state determination. For example, the UE 115-k may perform a TCI state determination as described with respect to FIG. 2, FIG. 5A, or FIG. 5B.

In some aspects, at 715, the UE 115-k may perform a TCI state application time determination. The TCI state application time determination may be performed as described with respect to FIG. 2 or FIG. 6. For instance, the UE 115-k may determine a TCI state application time as a maximum TCI state application time from multiple TCI state application times corresponding to multiple target cells, as a sum of TCI state application times corresponding to multiple target cell, or based at least in part on TCI state application time that increases with a quantity of target cells, among other examples.

In some aspects, at 720, the UE 115-k may receive a cell switch command from the network entity 105-k. For example, the UE 115-k may receive a cell switch command as described with respect to FIG. 2. The TCI state determination 710 may be performed based at least in part on whether the activation information is received before the cell switch command or via the cell switch command.

In some aspects, at 725, the UE 115-k may utilize the TCI state application time. For example, the UE 115-k may utilize the TCI state application time as described with respect to FIG. 2 or FIG. 6.

In some aspects, at 730, the UE 115-k may transmit a message to the network entity 105-l. For example, the UE 115-k may transmit the message to the network entity 105-l in accordance with the one or more determined TCI states.

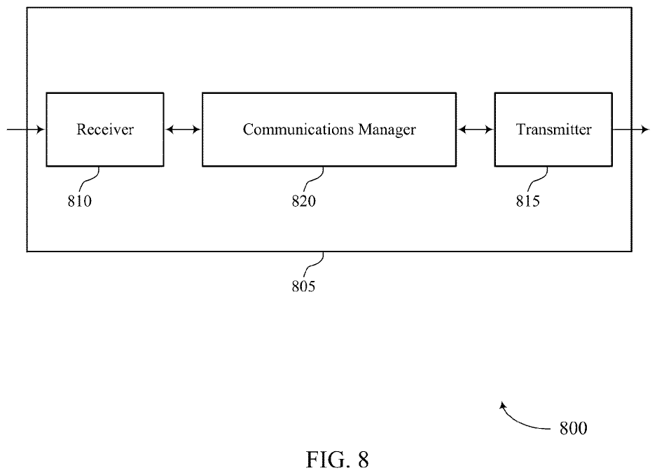

FIG. 8 shows a block diagram 800 of a device 805 that supports TCI activation in a candidate cell in accordance with one or more aspects of the present disclosure. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, and the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to TCI activation in a candidate cell). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to TCI activation in a candidate cell). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of TCI activation in a candidate cell as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), a graphics processing unit (GPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software) executed by at least one processor. If implemented in code executed by at least one processor, the functions of the communications manager 820, the receiver 810, the transmitter 815, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a UE in accordance with examples as disclosed herein. For example, the communications manager 820 is capable of, configured to, or operable to support a means for receiving, via a serving cell, control information that is indicative of one or more BWPs, where the one or more BWPs are associated with an activated TCI state of a candidate cell. The communications manager 820 is capable of, configured to, or operable to support a means for receiving, via the serving cell, a cell switch command that indicates for the UE to switch to the candidate cell via an LTM cell switching procedure. The communications manager 820 is capable of, configured to, or operable to support a means for communicating one or more messages with the candidate cell in accordance with the cell switch command and the activated TCI state using the one or more BWPs of the candidate cell.

Additionally, or alternatively, the communications manager 820 may support wireless communication at a UE in accordance with examples as disclosed herein. For example, the communications manager 820 is capable of, configured to, or operable to support a means for receiving, via a serving cell, activation information that is indicative of activation of a TCI state of a candidate cell. The communications manager 820 is capable of, configured to, or operable to support a means for receiving, via the serving cell, a cell switch command for the UE to switch to the candidate cell via an LTM cell switching procedure, where a determination of a TCI state of a set of multiple TCI states is based at least in part on whether the activation information is received with the cell switch command or before the cell switch command. The communications manager 820 is capable of, configured to, or operable to support a means for communicating with the candidate cell in accordance with the cell switch command and the TCI state.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for more efficient utilization of communication resources.

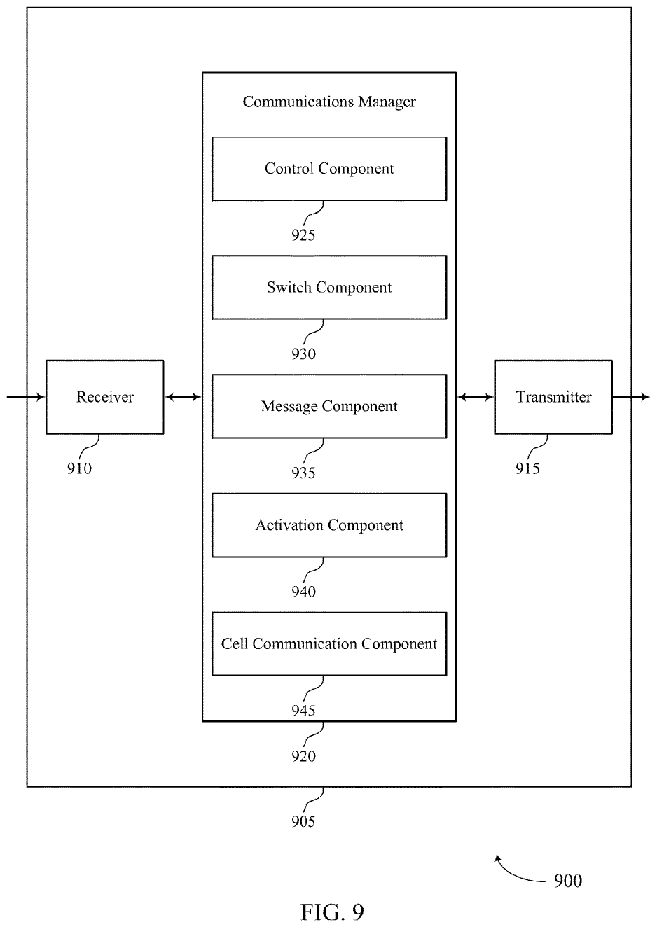

FIG. 9 shows a block diagram 900 of a device 905 that supports TCI activation in a candidate cell in accordance with one or more aspects of the present disclosure. The device 905 may be an example of aspects of a device 805 or a UE 115 as described herein. The device 905 may include a receiver 910, a transmitter 915, and a communications manager 920. The device 905, or one of more components of the device 905 (e.g., the receiver 910, the transmitter 915, and the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to TCI activation in a candidate cell). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to TCI activation in a candidate cell). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of TCI activation in a candidate cell as described herein. For example, the communications manager 920 may include a control component 925, a switch component 930, a message component 935, an activation component 940, a cell communication component 945, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a UE in accordance with examples as disclosed herein. The control component 925 is capable of, configured to, or operable to support a means for receiving, via a serving cell, control information that is indicative of one or more BWPs, where the one or more BWPs are associated with an activated TCI state of a candidate cell. The switch component 930 is capable of, configured to, or operable to support a means for receiving, via the serving cell, a cell switch command that indicates for the UE to switch to the candidate cell via an LTM cell switching procedure. The message component 935 is capable of, configured to, or operable to support a means for communicating one or more messages with the candidate cell in accordance with the cell switch command and the activated TCI state using the one or more BWPs of the candidate cell.

Additionally, or alternatively, the communications manager 920 may support wireless communication at a UE in accordance with examples as disclosed herein. The activation component 940 is capable of, configured to, or operable to support a means for receiving, via a serving cell, activation information that is indicative of activation of a TCI state of a candidate cell. The switch component 930 is capable of, configured to, or operable to support a means for receiving, via the serving cell, a cell switch command for the UE to switch to the candidate cell via an LTM cell switching procedure, where a determination of a TCI state of a set of multiple TCI states is based at least in part on whether the activation information is received with the cell switch command or before the cell switch command. The cell communication component 945 is capable of, configured to, or operable to support a means for communicating with the candidate cell in accordance with the cell switch command and the TCI state.

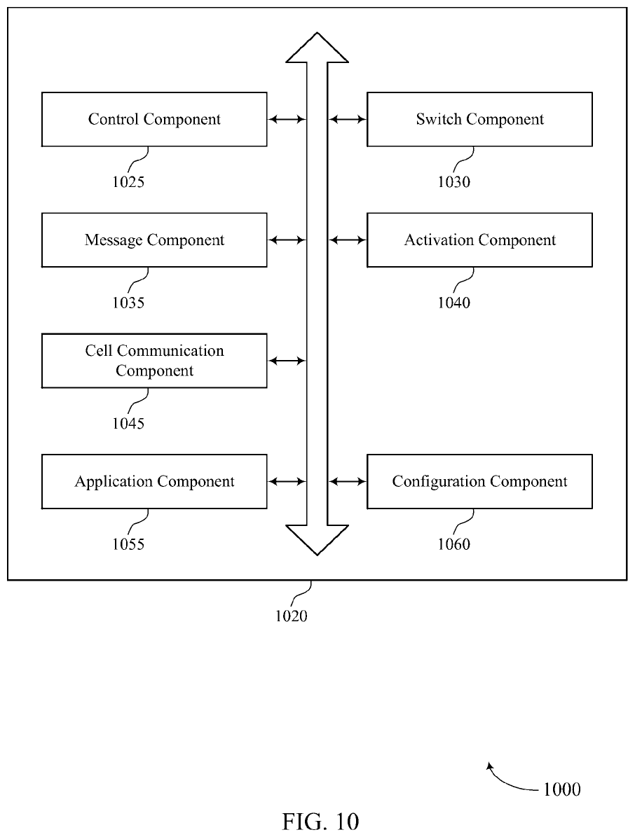

FIG. 10 shows a block diagram 1000 of a communications manager 1020 that supports TCI activation in a candidate cell in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of TCI activation in a candidate cell as described herein. For example, the communications manager 1020 may include a control component 1025, a switch component 1030, a message component 1035, an activation component 1040, a cell communication component 1045, an application component 1055, a configuration component 1060, or any combination thereof. Each of these components, or components or subcomponents thereof (e.g., one or more processors, one or more memories), may communicate, directly or indirectly, with one another (e.g., via one or more buses).

The communications manager 1020 may support wireless communication at a UE in accordance with examples as disclosed herein. The control component 1025 is capable of, configured to, or operable to support a means for receiving, via a serving cell, control information that is indicative of one or more BWPs, where the one or more BWPs are associated with an activated TCI state of a candidate cell. The switch component 1030 is capable of, configured to, or operable to support a means for receiving, via the serving cell, a cell switch command that indicates for the UE to switch to the candidate cell via an LTM cell switching procedure. The message component 1035 is capable of, configured to, or operable to support a means for communicating one or more messages with the candidate cell in accordance with the cell switch command and the activated TCI state using the one or more BWPs of the candidate cell.

In some examples, the one or more BWPs are indicated by inclusion, in the control information, of a BWP identifier of the candidate cell. In some examples, the control information is received via a TCI activation MAC-CE or via a cell switch MAC-CE.

In some examples, association of the one or more BWPs with the activated TCI state is via a rule applied to the control information.

In some examples, the control information is received via an RRC configuration message. In some examples, the rule indicates that the one or more BWPs include a first active BWP configured via the RRC configuration message or an initial BWP configured via the RRC configuration message.

In some examples, the control information is an indication of the activated TCI state and is received separate from candidate cell configuration signaling and serving cell configuration signaling and lacks an indication of the one or more BWPs. In some examples, the rule indicates that, based at least in part on lack of the indication of the one or more BWPs in the control information, the one or more BWPs include a set of multiple BWPs within a bandwidth of the candidate cell.

In some examples, the one or more BWPs are indicated by inclusion, in the control information, of a BWP identifier for a QCL'd source reference signal of the activated TCI state of the candidate cell, and where the control information is received via an RRC configuration message.

In some examples, association of the one or more BWPs with a QCL'd source reference signal of the activated TCI state is via a rule applied to the control information.

In some examples, the control information is received via an RRC configuration message. In some examples, the rule indicates that the one or more BWPs, associated with the QCL'd source reference signal, include a first active BWP configured via the RRC configuration message or an initial BWP configured via the RRC configuration message.

In some examples, the control information is an indication of the activated TCI state and is received separate from candidate cell configuration signaling and serving cell configuration signaling and lacks an indication of the one or more BWPs. In some examples, the rule indicates that, based at least in part on lack of the indication of the one or more BWPs in the control information, the one or more BWPs include a set of multiple BWPs, for the QCL'd source reference signal, within a bandwidth of the candidate cell.

In some examples, the QCL'd source reference signal is configured as a CSI-RS for mobility, is configured as a CSI-RS with an associated frequency allocation, or is configured as an SSB with an associated frequency allocation.

In some examples, the activated TCI state is one of a set of multiple activated TCI states for a corresponding set of multiple candidate cells, and the application component 1055 is capable of, configured to, or operable to support a means for determining a TCI state application time as a maximum TCI state application time among a set of multiple TCI state application times respectively associated with the set of multiple activated TCI states and with a set of multiple target cells, where communicating with the candidate cell includes communicating via at least one beam in accordance with the TCI state application time.

In some examples, the activated TCI state is one of a set of multiple activated TCI states for a corresponding set of multiple candidate cells, and the application component 1055 is capable of, configured to, or operable to support a means for determining a TCI state application time as a sum of a set of multiple TCI state application times respectively associated with the set of multiple activated TCI states and with a set of multiple target cells, where communicating with the candidate cell includes communicating via at least one beam in accordance with the TCI state application time.

In some examples, the application component 1055 is capable of, configured to, or operable to support a means for determining a TCI state application time, an RRC application time, or an RF tuning time based at least in part on a quantity of target cells, where the TCI state application time, the RRC application time, or the RF tuning time increases with an increasing quantity of target cells, and where communicating with the candidate cell includes communicating in accordance with the TCI state application time, the RRC application time, or the RF tuning time.

In some examples, the application component 1055 is capable of, configured to, or operable to support a means for determining a respective TCI state application time for each of a set of multiple target cells, and where communicating with the candidate cell includes communicating via a set of multiple beams in accordance with the respective TCI state application time for each of the set of multiple target cells.

Additionally, or alternatively, the communications manager 1020 may support wireless communication at a UE in accordance with examples as disclosed herein. The activation component 1040 is capable of, configured to, or operable to support a means for receiving, via a serving cell, activation information that is indicative of activation of a TCI state of a candidate cell. In some examples, the switch component 1030 is capable of, configured to, or operable to support a means for receiving, via the serving cell, a cell switch command for the UE to switch to the candidate cell via an LTM cell switching procedure, where a determination of a TCI state of a set of multiple TCI states is based at least in part on whether the activation information is received with the cell switch command or before the cell switch command. The cell communication component 1045 is capable of, configured to, or operable to support a means for communicating with the candidate cell in accordance with the cell switch command and the TCI state.

In some examples, the configuration component 1060 is capable of, configured to, or operable to support a means for determining the TCI state based at least in part on a TCI codepoint index received via the cell switch command when the activation information is received before the cell switch command, and where communicating with the candidate cell is performed with one or more TRPs.

In some examples, the configuration component 1060 is capable of, configured to, or operable to support a means for determining the TCI state based at least in part on a set of multiple TCI codepoint indexes associated with different control resource set indexes, where the set of multiple TCI codepoint indexes is received via the cell switch command when the activation information is received before the cell switch command, and where communicating with the candidate cell is performed with a set of multiple TRPs.

In some examples, the configuration component 1060 is capable of, configured to, or operable to support a means for determining the TCI state based at least in part on a TCI state index received via the cell switch command when the activation information is received with the cell switch command, and where communicating with the candidate cell is performed with a TRP.

In some examples, the configuration component 1060 is capable of, configured to, or operable to support a means for determining the TCI state based at least in part on a set of multiple TCI state indexes received via the cell switch command when the activation information is received with the cell switch command, and where communicating with the candidate cell is performed with a set of multiple TRPs.

In some examples, the activation information, the cell switch command, and a beam indication are received via a MAC-CE message.

In some examples, the activation information and a beam indication are received via at least one first MAC-CE message before the cell switch command. In some examples, the cell switch command is received via at least one second MAC-CE message.

In some examples, to support communicating with the candidate cell, the cell communication component 1045 is capable of, configured to, or operable to support a means for communicating on one or more channels with the candidate cell in accordance with the TCI state and a beam indicated via the cell switch command.

In some examples, the activated TCI state is one of a set of multiple activated TCI states for a corresponding set of multiple candidate cells, and the application component 1055 is capable of, configured to, or operable to support a means for determining a TCI state application time as a maximum TCI state application time among a set of multiple TCI state application times respectively associated with the set of multiple activated TCI states and with a set of multiple target cells, where communicating with the candidate cell includes communicating via at least one beam in accordance with the TCI state application time.

In some examples, the activated TCI state is one of a set of multiple activated TCI states for a corresponding set of multiple candidate cells, and the application component 1055 is capable of, configured to, or operable to support a means for determining a TCI state application time as a sum of a set of multiple TCI state application times respectively associated with the set of multiple activated TCI states and with a set of multiple target cells, where communicating with the candidate cell includes communicating via at least one beam in accordance with the TCI state application time.

In some examples, the application component 1055 is capable of, configured to, or operable to support a means for determining a TCI state application time, an RRC application time, or an RF tuning time based at least in part on a quantity of target cells, where the TCI state application time, the RRC application time, or the RF tuning time increases with an increasing quantity of target cells, and where communicating with the candidate cell includes communicating in accordance with the TCI state application time, the RRC application time, or the RF tuning time.

In some examples, the application component 1055 is capable of, configured to, or operable to support a means for determining a respective TCI state application time for each of a set of multiple target cells, and where communicating with the candidate cell includes communicating via a set of multiple beams in accordance with the respective TCI state application time for each of the set of multiple target cells.

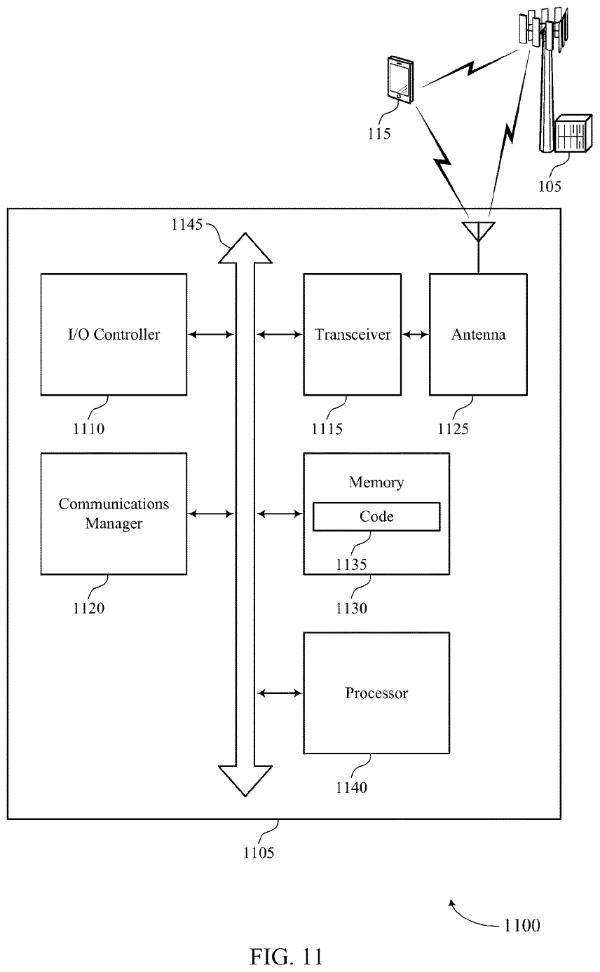

FIG. 11 shows a diagram of a system 1100 including a device 1105 that supports TCI activation in a candidate cell in accordance with one or more aspects of the present disclosure. The device 1105 may be an example of or include the components of a device 805, a device 905, or a UE 115 as described herein. The device 1105 may communicate (e.g., wirelessly) with one or more network entities 105, one or more UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable code 1135 including instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may contain, among other things, a basic I/O system (BIOS) which may control basic hardware or software operation such as the interaction with peripheral components or devices.

The at least one processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting TCI activation in a candidate cell). For example, the device 1105 or a component of the device 1105 may include at least one processor 1140 and at least one memory 1130 coupled with or to the at least one processor 1140, the at least one processor 1140 and at least one memory 1130 configured to perform various functions described herein. In some examples, the at least one processor 1140 may include multiple processors and the at least one memory 1130 may include multiple memories. One or more of the multiple processors may be coupled with one or more of the multiple memories, which may, individually or collectively, be configured to perform various functions herein.

The communications manager 1120 may support wireless communication at a UE in accordance with examples as disclosed herein. For example, the communications manager 1120 is capable of, configured to, or operable to support a means for receiving, via a serving cell, control information that is indicative of one or more BWPs, where the one or more BWPs are associated with an activated TCI state of a candidate cell. The communications manager 1120 is capable of, configured to, or operable to support a means for receiving, via the serving cell, a cell switch command that indicates for the UE to switch to the candidate cell via an LTM cell switching procedure. The communications manager 1120 is capable of, configured to, or operable to support a means for communicating one or more messages with the candidate cell in accordance with the cell switch command and the activated TCI state using the one or more BWPs of the candidate cell.

Additionally, or alternatively, the communications manager 1120 may support wireless communication at a UE in accordance with examples as disclosed herein. For example, the communications manager 1120 is capable of, configured to, or operable to support a means for receiving, via a serving cell, activation information that is indicative of activation of a TCI state of a candidate cell. The communications manager 1120 is capable of, configured to, or operable to support a means for receiving, via the serving cell, a cell switch command for the UE to switch to the candidate cell via an LTM cell switching procedure, where a determination of a TCI state of a set of multiple TCI states is based at least in part on whether the activation information is received with the cell switch command or before the cell switch command. The communications manager 1120 is capable of, configured to, or operable to support a means for communicating with the candidate cell in accordance with the cell switch command and the TCI state.

By including or configuring the communications manager 1120 in accordance with examples as described herein, the device 1105 may support techniques for improved communication reliability, higher mobility, reduced latency, improved user experience related to more efficient utilization of communication resources, or improved coordination between devices.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of TCI activation in a candidate cell as described herein, or the at least one processor 1140 and the at least one memory 1130 may be otherwise configured to, individually or collectively, perform or support such operations.

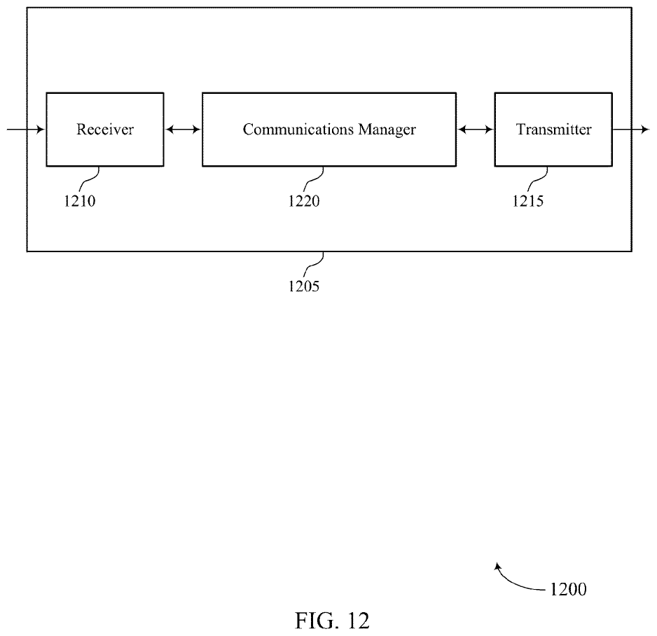

FIG. 12 shows a block diagram 1200 of a device 1205 that supports TCI activation in a candidate cell in accordance with one or more aspects of the present disclosure. The device 1205 may be an example of aspects of a network entity 105 as described herein. The device 1205 may include a receiver 1210, a transmitter 1215, and a communications manager 1220. The device 1205, or one or more components of the device 1205 (e.g., the receiver 1210, the transmitter 1215, and the communications manager 1220), may include at least one processor, which may be coupled with at least one memory, to, individually or collectively, support or enable the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations thereof or various components thereof may be examples of means for performing various aspects of TCI activation in a candidate cell as described herein. For example, the communications manager 1220, the receiver 1210, the transmitter 1215, or various combinations or components thereof may be capable of performing one or more of the functions described herein.

In some examples, the communications manager 1220, the receiver 1210, the transmitter 1215, or various combinations or components thereof may be implemented in hardware (e.g., in communications management circuitry). The hardware may include at least one of a processor, a DSP, a CPU, a GPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1220, the receiver 1210, the transmitter 1215, or various combinations or components thereof may be implemented in code (e.g., as communications management software) executed by at least one processor. If implemented in code executed by at least one processor, the functions of the communications manager 1220, the receiver 1210, the transmitter 1215, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a network entity in accordance with examples as disclosed herein. For example, the communications manager 1220 is capable of, configured to, or operable to support a means for communicating with a UE via a serving cell. The communications manager 1220 is capable of, configured to, or operable to support a means for transmitting, to the UE, control information that is indicative of one or more BWPs, where the one or more BWPs are associated with an activated TCI state of a candidate cell. The communications manager 1220 is capable of, configured to, or operable to support a means for transmitting, to the UE, a cell switch command that indicates for the UE to switch to the candidate cell via an LTM cell switching procedure.

Additionally, or alternatively, the communications manager 1220 may support wireless communication at a network entity in accordance with examples as disclosed herein. For example, the communications manager 1220 is capable of, configured to, or operable to support a means for communicating with a UE via a serving cell. The communications manager 1220 is capable of, configured to, or operable to support a means for transmitting, to the UE, activation information that is indicative of activation of a TCI state of a candidate cell. The communications manager 1220 is capable of, configured to, or operable to support a means for transmitting, to the UE, a cell switch command for the UE to switch to the candidate cell via an LTM cell switching procedure, where whether the activation information is transmitted with the cell switch command or before the cell switch command is indicative of a TCI state of a set of multiple TCI states.

By including or configuring the communications manager 1220 in accordance with examples as described herein, the device 1205 (e.g., at least one processor controlling or otherwise coupled with the receiver 1210, the transmitter 1215, the communications manager 1220, or a combination thereof) may support techniques for more efficient utilization of communication resources.

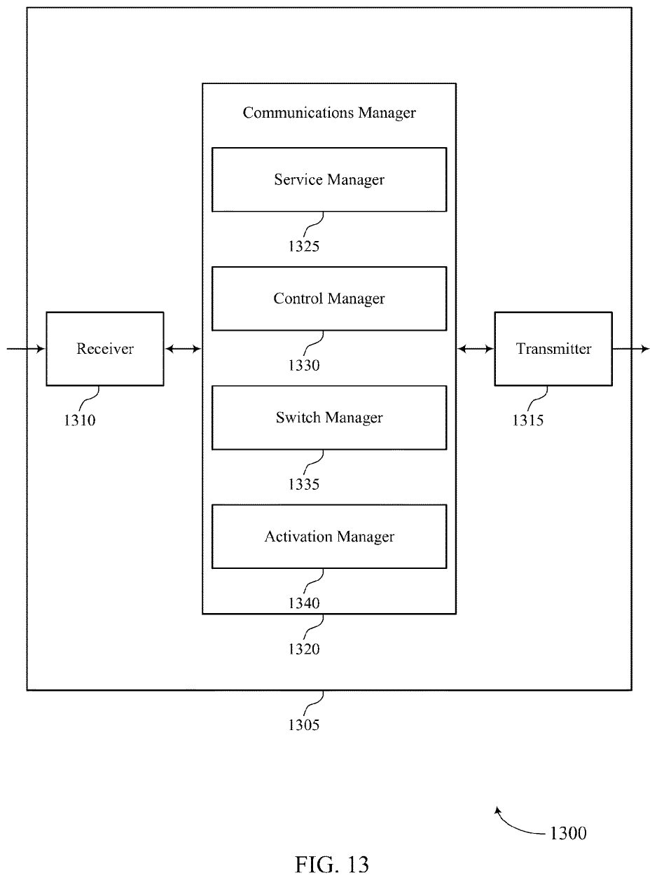

FIG. 13 shows a block diagram 1300 of a device 1305 that supports TCI activation in a candidate cell in accordance with one or more aspects of the present disclosure. The device 1305 may be an example of aspects of a device 1205 or a network entity 105 as described herein. The device 1305 may include a receiver 1310, a transmitter 1315, and a communications manager 1320. The device 1305, or one of more components of the device 1305 (e.g., the receiver 1310, the transmitter 1315, and the communications manager 1320), may include at least one processor, which may be coupled with at least one memory, to support the described techniques. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of TCI activation in a candidate cell as described herein. For example, the communications manager 1320 may include a service manager 1325, a control manager 1330, a switch manager 1335, an activation manager 1340, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communication at a network entity in accordance with examples as disclosed herein. The service manager 1325 is capable of, configured to, or operable to support a means for communicating with a UE via a serving cell. The control manager 1330 is capable of, configured to, or operable to support a means for transmitting, to the UE, control information that is indicative of one or more BWPs, where the one or more BWPs are associated with an activated TCI state of a candidate cell. The switch manager 1335 is capable of, configured to, or operable to support a means for transmitting, to the UE, a cell switch command that indicates for the UE to switch to the candidate cell via an LTM cell switching procedure.

Additionally, or alternatively, the communications manager 1320 may support wireless communication at a network entity in accordance with examples as disclosed herein. The service manager 1325 is capable of, configured to, or operable to support a means for communicating with a UE via a serving cell. The activation manager 1340 is capable of, configured to, or operable to support a means for transmitting, to the UE, activation information that is indicative of activation of a TCI state of a candidate cell. The switch manager 1335 is capable of, configured to, or operable to support a means for transmitting, to the UE, a cell switch command for the UE to switch to the candidate cell via an LTM cell switching procedure, where whether the activation information is transmitted with the cell switch command or before the cell switch command is indicative of a TCI state of a set of multiple TCI states.

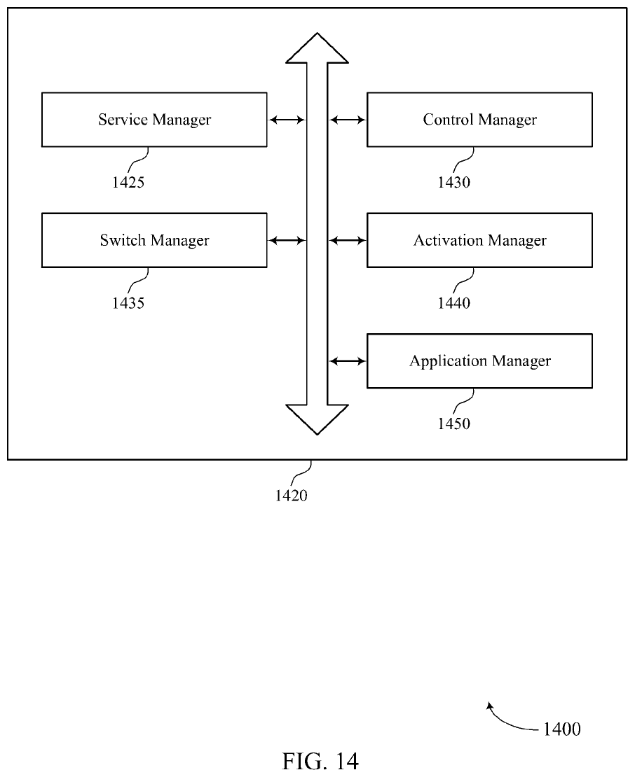

FIG. 14 shows a block diagram 1400 of a communications manager 1420 that supports TCI activation in a candidate cell in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of TCI activation in a candidate cell as described herein. For example, the communications manager 1420 may include a service manager 1425, a control manager 1430, a switch manager 1435, an activation manager 1440, an application manager 1450, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1420 may support wireless communication at a network entity in accordance with examples as disclosed herein. The service manager 1425 is capable of, configured to, or operable to support a means for communicating with a UE via a serving cell. The control manager 1430 is capable of, configured to, or operable to support a means for transmitting, to the UE, control information that is indicative of one or more BWPs, where the one or more BWPs are associated with an activated TCI state of a candidate cell. The switch manager 1435 is capable of, configured to, or operable to support a means for transmitting, to the UE, a cell switch command that indicates for the UE to switch to the candidate cell via an LTM cell switching procedure.

In some examples, the one or more BWPs are indicated by inclusion, in the control information, of a BWP identifier of the candidate cell. In some examples, the control information is transmitted via a TCI activation MAC-CE or via a cell switch MAC-CE.

In some examples, association of the one or more BWPs with the activated TCI state is via a rule applied to the control information.

In some examples, the control information is transmitted via an RRC configuration message. In some examples, the rule indicates that the one or more BWPs include a first active BWP configured via the RRC configuration message or an initial BWP configured via the RRC configuration message.

In some examples, the control information is an indication of the activated TCI state and is transmitted separate from candidate cell configuration signaling and serving cell configuration signaling and lacks an indication of the one or more BWPs. In some examples, the rule indicates that, based at least in part on lack of the indication of the one or more BWPs in the control information, the one or more BWPs include a set of multiple BWPs within a bandwidth of the candidate cell.

In some examples, the one or more BWPs are indicated by inclusion, in the control information, of a BWP identifier for a QCL'd source reference signal of the activated TCI state of the candidate cell, and where the control information is transmitted via an RRC configuration message.

In some examples, association of the one or more BWPs with a QCL'd source reference signal of the activated TCI state is via a rule applied to the control information.

In some examples, the control information is transmitted via an RRC configuration message. In some examples, the rule indicates that the one or more BWPs, associated with the QCL'd source reference signal, include a first active BWP configured via the RRC configuration message or an initial BWP configured via the RRC configuration message.

In some examples, the control information is an indication of the activated TCI state and is transmitted separate from candidate cell configuration signaling and serving cell configuration signaling and lacks an indication of the one or more BWPs. In some examples, the rule indicates that, based at least in part on lack of the indication of the one or more BWPs in the control information, the one or more BWPs include a set of multiple BWPs, for the QCL'd source reference signal, within a bandwidth of the candidate cell.

In some examples, the QCL'd source reference signal is configured as a CSI-RS for mobility, is configured as a CSI-RS with an associated frequency allocation, or is configured as an SSB with an associated frequency allocation.

In some examples, the activated TCI state is one of a set of multiple activated TCI states for a corresponding set of multiple candidate cells, and the application manager 1450 is capable of, configured to, or operable to support a means for determining a TCI state application time as a maximum TCI state application time among a set of multiple TCI state application times respectively associated with the set of multiple activated TCI states and with a set of multiple target cells.

In some examples, the activated TCI state is one of a set of multiple activated TCI states for a corresponding set of multiple candidate cells, and the application manager 1450 is capable of, configured to, or operable to support a means for determining a TCI state application time as a sum of a set of multiple TCI state application times respectively associated with the set of multiple activated TCI states and with a set of multiple target cells.

In some examples, the application manager 1450 is capable of, configured to, or operable to support a means for determining a TCI state application time, an RRC application time, or an RF tuning time based at least in part on a quantity of target cells, where the TCI state application time, the RRC application time, or the RF tuning time increases with an increasing quantity of target cells.

In some examples, the application manager 1450 is capable of, configured to, or operable to support a means for determining a respective TCI state application time for each of a set of multiple target cells.

Additionally, or alternatively, the communications manager 1420 may support wireless communication at a network entity in accordance with examples as disclosed herein. In some examples, the service manager 1425 is capable of, configured to, or operable to support a means for communicating with a UE via a serving cell. The activation manager 1440 is capable of, configured to, or operable to support a means for transmitting, to the UE, activation information that is indicative of activation of a TCI state of a candidate cell. In some examples, the switch manager 1435 is capable of, configured to, or operable to support a means for transmitting, to the UE, a cell switch command for the UE to switch to the candidate cell via an LTM cell switching procedure, where whether the activation information is transmitted with the cell switch command or before the cell switch command is indicative of a TCI state of a set of multiple TCI states.

In some examples, when the activation information is transmitted before the cell switch command, a TCI codepoint index transmitted via the cell switch command is indicative of the TCI state.

In some examples, when the activation information is transmitted before the cell switch command, a set of multiple TCI codepoint indexes associated with different control resource set indexes is indicative of the TCI state, where the set of multiple TCI codepoint indexes is transmitted via the cell switch command.

In some examples, when the activation information is transmitted with the cell switch command, a TCI state index transmitted via the cell switch command is indicative of the TCI state.

In some examples, when the activation information is transmitted with the cell switch command, a set of multiple TCI state indexes transmitted via the cell switch command is indicative of the TCI state.

In some examples, the activation information, the cell switch command, and a beam indication are transmitted via a MAC-CE message.

In some examples, the activation information and a beam indication are transmitted via at least one first MAC-CE message before the cell switch command. In some examples, the cell switch command is transmitted via at least one second MAC-CE message.

In some examples, the activated TCI state is one of a set of multiple activated TCI states for a corresponding set of multiple candidate cells, and the application manager 1450 is capable of, configured to, or operable to support a means for determining a TCI state application time as a maximum TCI state application time among a set of multiple TCI state application times respectively associated with the set of multiple activated TCI states and with a set of multiple target cells.

In some examples, the activated TCI state is one of a set of multiple activated TCI states for a corresponding set of multiple candidate cells, and the application manager 1450 is capable of, configured to, or operable to support a means for determining a TCI state application time as a sum of a set of multiple TCI state application times respectively associated with the set of multiple activated TCI states and with a set of multiple target cells.

In some examples, the application manager 1450 is capable of, configured to, or operable to support a means for determining a TCI state application time, an RRC application time, or an RF tuning time based at least in part on a quantity of target cells, where the TCI state application time, the RRC application time, or the RF tuning time increases with an increasing quantity of target cells.

In some examples, the application manager 1450 is capable of, configured to, or operable to support a means for determining a respective TCI state application time for each of a set of multiple target cells.

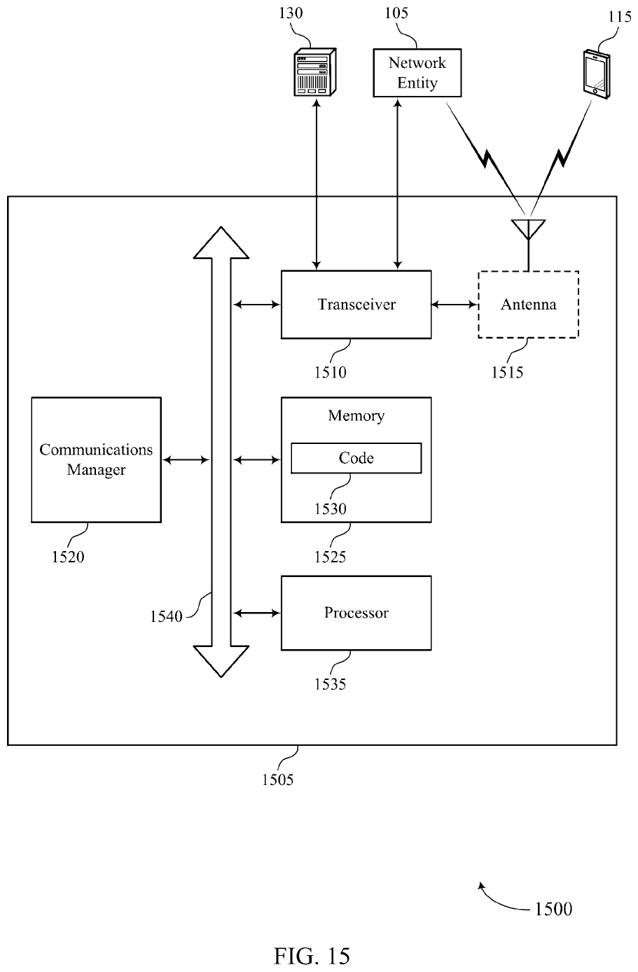

FIG. 15 shows a diagram of a system 1500 including a device 1505 that supports TCI activation in a candidate cell in accordance with one or more aspects of the present disclosure. The device 1505 may be an example of or include the components of a device 1205, a device 1305, or a network entity 105 as described herein. The device 1505 may communicate with one or more network entities 105, one or more UEs 115, or any combination thereof, which may include communications over one or more wired interfaces, over one or more wireless interfaces, or any combination thereof. The device 1505 may include components that support outputting and obtaining communications, such as a communications manager 1520, a transceiver 1510, an antenna 1515, at least one memory 1525, code 1530, and at least one processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. In some implementations, the transceiver 1510 may include one or more interfaces, such as one or more interfaces coupled with the one or more antennas 1515 that are configured to support various receiving or obtaining operations, or one or more interfaces coupled with the one or more antennas 1515 that are configured to support various transmitting or outputting operations, or a combination thereof. In some implementations, the transceiver 1510 may include or be configured for coupling with one or more processors or one or more memory components that are operable to perform or support operations based at least in part on received or obtained information or signals, or to generate information or other signals for transmission or other outputting, or any combination thereof. In some implementations, the transceiver 1510, or the transceiver 1510 and the one or more antennas 1515, or the transceiver 1510 and the one or more antennas 1515 and one or more processors or one or more memory components (e.g., the at least one processor 1535, the at least one memory 1525, or both), may be included in a chip or chip assembly that is installed in the device 1505. In some examples, the transceiver 1510 may be operable to support communications via one or more communications links (e.g., a communication link 125, a backhaul communication link 120, a midhaul communication link 162, a fronthaul communication link 168).

The at least one memory 1525 may include RAM, ROM, or any combination thereof. The at least one memory 1525 may store computer-readable, computer-executable code 1530 including instructions that, when executed by one or more of the at least one processor 1535, cause the device 1505 to perform various functions described herein. The code 1530 may be stored in a non-transitory computer-readable medium such as system memory or another type of memory. In some cases, the code 1530 may not be directly executable by a processor of the at least one processor 1535 but may cause a computer (e.g., when compiled and executed) to perform functions described herein. In some cases, the at least one memory 1525 may contain, among other things, a BIOS which may control basic hardware or software operation such as the interaction with peripheral components or devices. In some examples, the at least one processor 1535 may include multiple processors and the at least one memory 1525 may include multiple memories. One or more of the multiple processors may be coupled with one or more of the multiple memories which may, individually or collectively, be configured to perform various functions herein (for example, as part of a processing system).

The at least one processor 1535 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1535 may be configured to operate a memory array using a memory controller. In some other cases, a memory controller may be integrated into one or more of the at least one processor 1535. The at least one processor 1535 may be configured to execute computer-readable instructions stored in a memory (e.g., one or more of the at least one memory 1525) to cause the device 1505 to perform various functions (e.g., functions or tasks supporting TCI activation in a candidate cell). For example, the device 1505 or a component of the device 1505 may include at least one processor 1535 and at least one memory 1525 coupled with one or more of the at least one processor 1535, the at least one processor 1535 and the at least one memory 1525 configured to perform various functions described herein. The at least one processor 1535 may be an example of a cloud-computing platform (e.g., one or more physical nodes and supporting software such as operating systems, virtual machines, or container instances) that may host the functions (e.g., by executing code 1530) to perform the functions of the device 1505. The at least one processor 1535 may be any one or more suitable processors capable of executing scripts or instructions of one or more software programs stored in the device 1505 (such as within one or more of the at least one memory 1525). In some implementations, the at least one processor 1535 may be a component of a processing system. A processing system may generally refer to a system or series of machines or components that receives inputs and processes the inputs to produce a set of outputs (which may be passed to other systems or components of, for example, the device 1505). For example, a processing system of the device 1505 may refer to a system including the various other components or subcomponents of the device 1505, such as the at least one processor 1535, or the transceiver 1510, or the communications manager 1520, or other components or combinations of components of the device 1505. The processing system of the device 1505 may interface with other components of the device 1505, and may process information received from other components (such as inputs or signals) or output information to other components. For example, a chip or modem of the device 1505 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1505 may transmit information output from the chip or modem. Additionally, or alternatively, in some implementations, the one or more interfaces may refer to an interface between the processing system of the chip or modem and a receiver, such that the device 1505 may obtain information or signal inputs, and the information may be passed to the processing system. A person having ordinary skill in the art will readily recognize that a first interface also may obtain information or signal inputs, and a second interface also may output information or signal outputs.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the at least one memory 1525, the code 1530, and the at least one processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with other network entities 105, and may include a controller or scheduler for controlling communications with UEs 115 in cooperation with other network entities 105. In some examples, the communications manager 1520 may support an X2 interface within an LTE/LTE-A wireless communications network technology to provide communication between network entities 105.

The communications manager 1520 may support wireless communication at a network entity in accordance with examples as disclosed herein. For example, the communications manager 1520 is capable of, configured to, or operable to support a means for communicating with a UE via a serving cell. The communications manager 1520 is capable of, configured to, or operable to support a means for transmitting, to the UE, control information that is indicative of one or more BWPs, where the one or more BWPs are associated with an activated TCI state of a candidate cell. The communications manager 1520 is capable of, configured to, or operable to support a means for transmitting, to the UE, a cell switch command that indicates for the UE to switch to the candidate cell via an LTM cell switching procedure.

Additionally, or alternatively, the communications manager 1520 may support wireless communication at a network entity in accordance with examples as disclosed herein. For example, the communications manager 1520 is capable of, configured to, or operable to support a means for communicating with a UE via a serving cell. The communications manager 1520 is capable of, configured to, or operable to support a means for transmitting, to the UE, activation information that is indicative of activation of a TCI state of a candidate cell. The communications manager 1520 is capable of, configured to, or operable to support a means for transmitting, to the UE, a cell switch command for the UE to switch to the candidate cell via an LTM cell switching procedure, where whether the activation information is transmitted with the cell switch command or before the cell switch command is indicative of a TCI state of a set of multiple TCI states.

By including or configuring the communications manager 1520 in accordance with examples as described herein, the device 1505 may support techniques for improved communication reliability, higher mobility, reduced latency, improved user experience related to reduced processing, more efficient utilization of communication resources, or improved coordination between devices.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the transceiver 1510, one or more of the at least one processor 1535, one or more of the at least one memory 1525, the code 1530, or any combination thereof (for example, by a processing system including at least a portion of the at least one processor 1535, the at least one memory 1525, the code 1530, or any combination thereof). For example, the code 1530 may include instructions executable by one or more of the at least one processor 1535 to cause the device 1505 to perform various aspects of TCI activation in a candidate cell as described herein, or the at least one processor 1535 and the at least one memory 1525 may be otherwise configured to, individually or collectively, perform or support such operations.

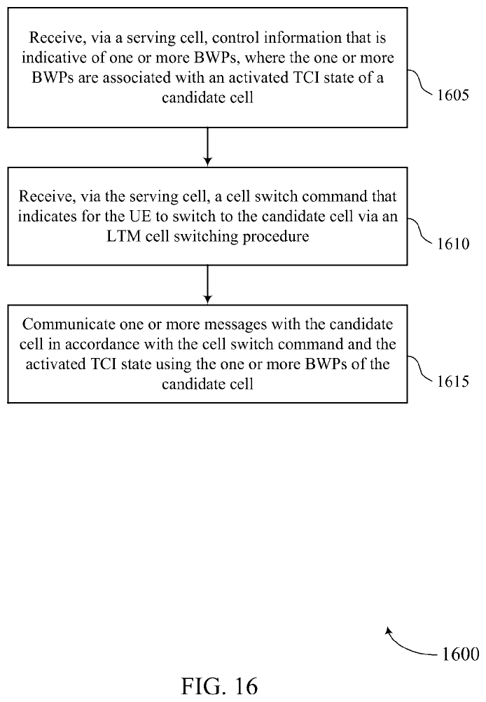

FIG. 16 shows a flowchart illustrating a method 1600 that supports TCI activation in a candidate cell in accordance with aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include receiving, via a serving cell, control information that is indicative of one or more BWPs, where the one or more BWPs are associated with an activated TCI state of a candidate cell. The operations of block 1605 may be performed in accordance with examples as disclosed herein. In some examples, aspects of the operations of 1605 may be performed by a control component 1025 as described with reference to FIG. 10.

At 1610, the method may include receiving, via the serving cell, a cell switch command that indicates for the UE to switch to the candidate cell via an LTM cell switching procedure. The operations of block 1610 may be performed in accordance with examples as disclosed herein. In some examples, aspects of the operations of 1610 may be performed by a switch component 1030 as described with reference to FIG. 10.

At 1615, the method may include communicating one or more messages with the candidate cell in accordance with the cell switch command and the activated TCI state using the one or more BWPs of the candidate cell. The operations of block 1615 may be performed in accordance with examples as disclosed herein. In some examples, aspects of the operations of 1615 may be performed by a message component 1035 as described with reference to FIG. 10.

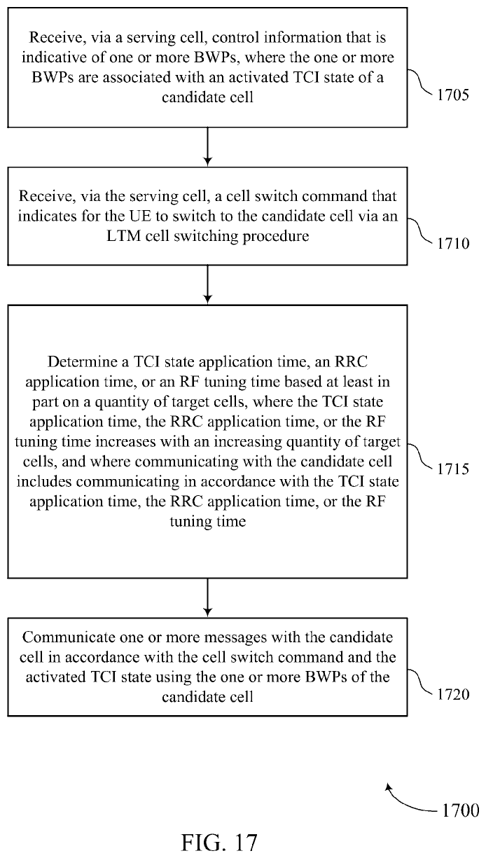

FIG. 17 shows a flowchart illustrating a method 1700 that supports TCI activation in a candidate cell in accordance with aspects of the present disclosure. The operations of the method 1700 may be implemented by a UE or its components as described herein. For example, the operations of the method 1700 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1705, the method may include receiving, via a serving cell, control information that is indicative of one or more BWPs, where the one or more BWPs are associated with an activated TCI state of a candidate cell. The operations of block 1705 may be performed in accordance with examples as disclosed herein. In some examples, aspects of the operations of 1705 may be performed by a control component 1025 as described with reference to FIG. 10.

At 1710, the method may include receiving, via the serving cell, a cell switch command that indicates for the UE to switch to the candidate cell via an LTM cell switching procedure. The operations of block 1710 may be performed in accordance with examples as disclosed herein. In some examples, aspects of the operations of 1710 may be performed by a switch component 1030 as described with reference to FIG. 10.

At 1715, the method may include determining a TCI state application time, an RRC application time, or an RF tuning time based at least in part on a quantity of target cells, where the TCI state application time, the RRC application time, or the RF tuning time increases with an increasing quantity of target cells, and where communicating with the candidate cell includes communicating in accordance with the TCI state application time, the RRC application time, or the RF tuning time. The operations of block 1715 may be performed in accordance with examples as disclosed herein. In some examples, aspects of the operations of 1715 may be performed by an application component 1055 as described with reference to FIG. 10.

At 1720, the method may include communicating one or more messages with the candidate cell in accordance with the cell switch command and the activated TCI state using the one or more BWPs of the candidate cell. The operations of block 1720 may be performed in accordance with examples as disclosed herein. In some examples, aspects of the operations of 1720 may be performed by a message component 1035 as described with reference to FIG. 10.

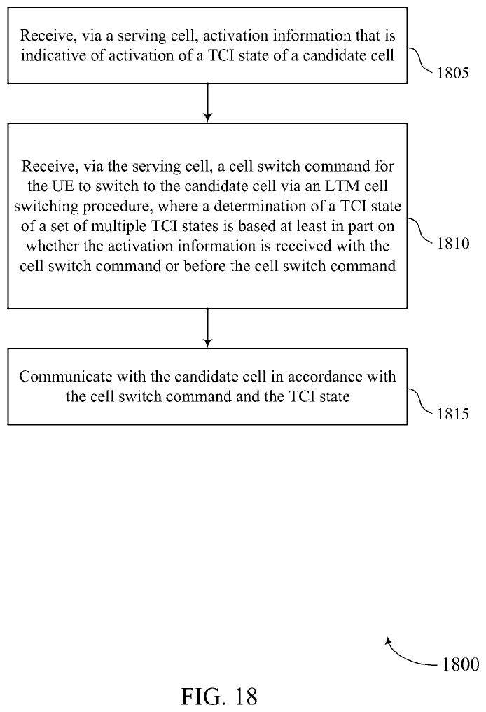

FIG. 18 shows a flowchart illustrating a method 1800 that supports TCI activation in a candidate cell in accordance with aspects of the present disclosure. The operations of the method 1800 may be implemented by a UE or its components as described herein. For example, the operations of the method 1800 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1805, the method may include receiving, via the serving cell, a cell switch command for the UE to switch to the candidate cell via an LTM cell switching procedure, where a determination of a TCI state of a set of multiple TCI states is based at least in part on whether the activation information is received with the cell switch command or before the cell switch command. The operations of block 1805 may be performed in accordance with examples as disclosed herein. In some examples, aspects of the operations of 1805 may be performed by a switch component 1030 as described with reference to FIG. 10.

At 1810, the method may include receiving, via a serving cell, activation information that is indicative of activation of a TCI state of a candidate cell. The operations of block 1810 may be performed in accordance with examples as disclosed herein. In some examples, aspects of the operations of 1810 may be performed by an activation component 1040 as described with reference to FIG. 10.

At 1815, the method may include communicating with the candidate cell in accordance with the cell switch command and the TCI state. The operations of block 1815 may be performed in accordance with examples as disclosed herein. In some examples, aspects of the operations of 1815 may be performed by a cell communication component 1045 as described with reference to FIG. 10.

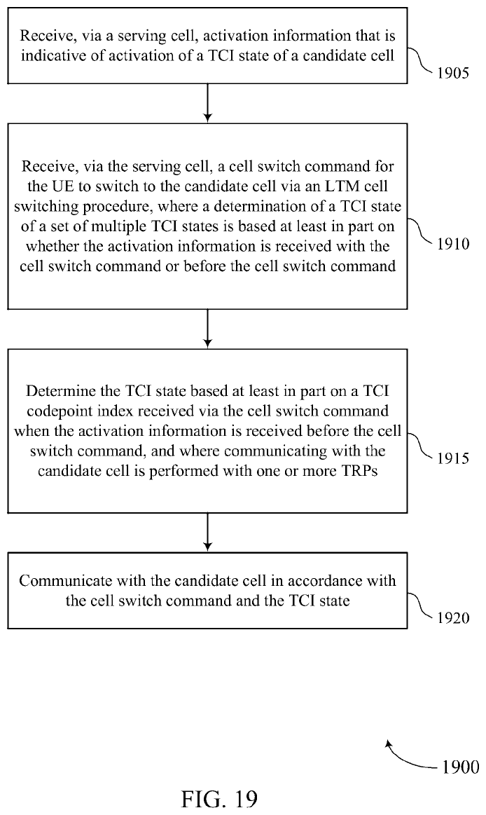

FIG. 19 shows a flowchart illustrating a method 1900 that supports TCI activation in a candidate cell in accordance with aspects of the present disclosure. The operations of the method 1900 may be implemented by a UE or its components as described herein. For example, the operations of the method 1900 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1905, the method may include receiving, via the serving cell, a cell switch command for the UE to switch to the candidate cell via an LTM cell switching procedure, where a determination of a TCI state of a set of multiple TCI states is based at least in part on whether the activation information is received with the cell switch command or before the cell switch command. The operations of block 1905 may be performed in accordance with examples as disclosed herein. In some examples, aspects of the operations of 1905 may be performed by a switch component 1030 as described with reference to FIG. 10.

At 1910, the method may include receiving, via a serving cell, activation information that is indicative of activation of a TCI state of a candidate cell. The operations of block 1910 may be performed in accordance with examples as disclosed herein. In some examples, aspects of the operations of 1910 may be performed by an activation component 1040 as described with reference to FIG. 10.

At 1915, the method may include determining the TCI state based at least in part on a TCI codepoint index received via the cell switch command when the activation information is received before the cell switch command, and where communicating with the candidate cell is performed with one or more TRPs. The operations of block 1915 may be performed in accordance with examples as disclosed herein. In some examples, aspects of the operations of 1915 may be performed by a configuration component 1060 as described with reference to FIG. 10.

At 1920, the method may include communicating with the candidate cell in accordance with the cell switch command and the TCI state. The operations of block 1920 may be performed in accordance with examples as disclosed herein. In some examples, aspects of the operations of 1920 may be performed by a cell communication component 1045 as described with reference to FIG. 10.

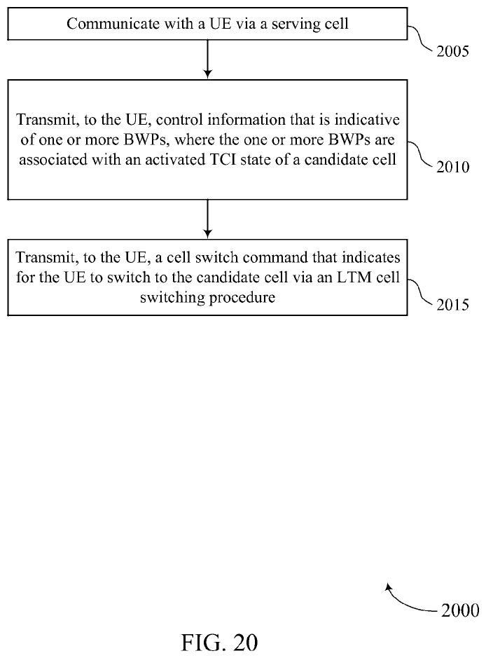

FIG. 20 shows a flowchart illustrating a method 2000 that supports TCI activation in a candidate cell in accordance with aspects of the present disclosure. The operations of the method 2000 may be implemented by a network entity or its components as described herein. For example, the operations of the method 2000 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 2005, the method may include communicating with a UE via a serving cell. The operations of block 2005 may be performed in accordance with examples as disclosed herein. In some examples, aspects of the operations of 2005 may be performed by a service manager 1425 as described with reference to FIG. 14.

At 2010, the method may include transmitting, to the UE, control information that is indicative of one or more BWPs, where the one or more BWPs are associated with an activated TCI state of a candidate cell. The operations of block 2010 may be performed in accordance with examples as disclosed herein. In some examples, aspects of the operations of 2010 may be performed by a control manager 1430 as described with reference to FIG. 14.

At 2015, the method may include transmitting, to the UE, a cell switch command that indicates for the UE to switch to the candidate cell via an LTM cell switching procedure. The operations of block 2015 may be performed in accordance with examples as disclosed herein. In some examples, aspects of the operations of 2015 may be performed by a switch manager 1435 as described with reference to FIG. 14.

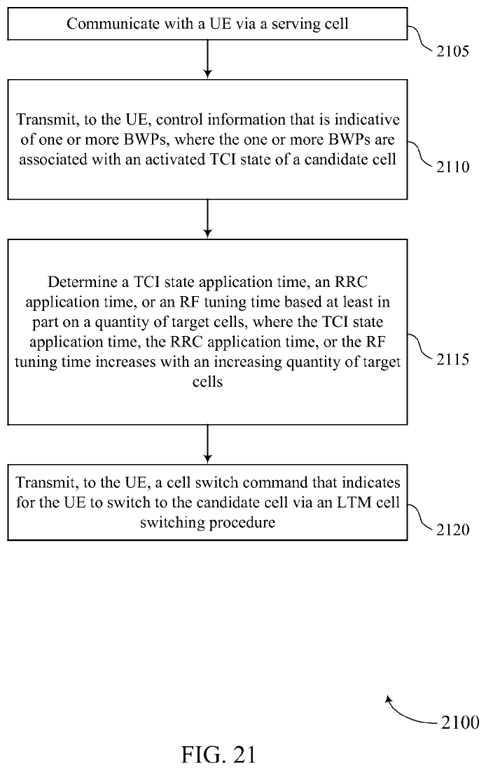

FIG. 21 shows a flowchart illustrating a method 2100 that supports TCI activation in a candidate cell in accordance with aspects of the present disclosure. The operations of the method 2100 may be implemented by a network entity or its components as described herein. For example, the operations of the method 2100 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 2105, the method may include communicating with a UE via a serving cell. The operations of block 2105 may be performed in accordance with examples as disclosed herein. In some examples, aspects of the operations of 2105 may be performed by a service manager 1425 as described with reference to FIG. 14.

At 2110, the method may include transmitting, to the UE, control information that is indicative of one or more BWPs, where the one or more BWPs are associated with an activated TCI state of a candidate cell. The operations of block 2110 may be performed in accordance with examples as disclosed herein. In some examples, aspects of the operations of 2110 may be performed by a control manager 1430 as described with reference to FIG. 14.

At 2115, the method may include determining a TCI state application time, an RRC application time, or an RF tuning time based at least in part on a quantity of target cells, where the TCI state application time, the RRC application time, or the RF tuning time increases with an increasing quantity of target cells. The operations of block 2115 may be performed in accordance with examples as disclosed herein. In some examples, aspects of the operations of 2115 may be performed by an application manager 1450 as described with reference to FIG. 14.

At 2120, the method may include transmitting, to the UE, a cell switch command that indicates for the UE to switch to the candidate cell via an LTM cell switching procedure. The operations of block 2120 may be performed in accordance with examples as disclosed herein. In some examples, aspects of the operations of 2120 may be performed by a switch manager 1435 as described with reference to FIG. 14.

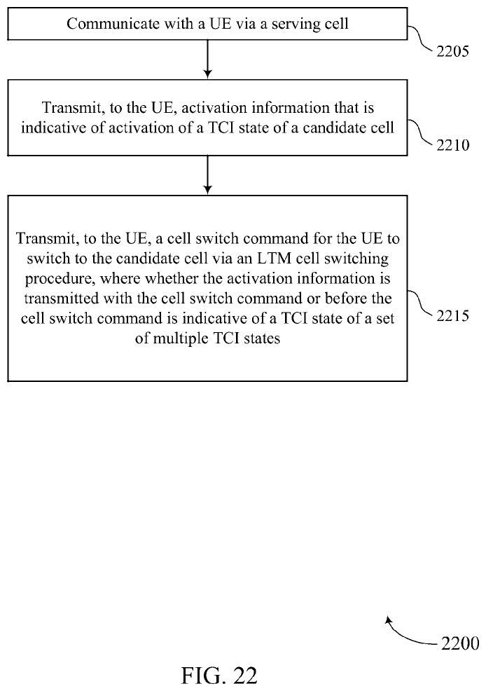

FIG. 22 shows a flowchart illustrating a method 2200 that supports TCI activation in a candidate cell in accordance with aspects of the present disclosure. The operations of the method 2200 may be implemented by a network entity or its components as described herein. For example, the operations of the method 2200 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 2205, the method may include communicating with a UE via a serving cell. The operations of block 2205 may be performed in accordance with examples as disclosed herein. In some examples, aspects of the operations of 2205 may be performed by a service manager 1425 as described with reference to FIG. 14.

At 2210, the method may include transmitting, to the UE, activation information that is indicative of activation of a TCI state of a candidate cell. The operations of block 2210 may be performed in accordance with examples as disclosed herein. In some examples, aspects of the operations of 2210 may be performed by an activation manager 1440 as described with reference to FIG. 14.

At 2215, the method may include transmitting, to the UE, a cell switch command for the UE to switch to the candidate cell via an LTM cell switching procedure, where whether the activation information is transmitted with the cell switch command or before the cell switch command is indicative of a TCI state of a set of multiple TCI states. The operations of block 2215 may be performed in accordance with examples as disclosed herein. In some examples, aspects of the operations of 2215 may be performed by a switch manager 1435 as described with reference to FIG. 14.

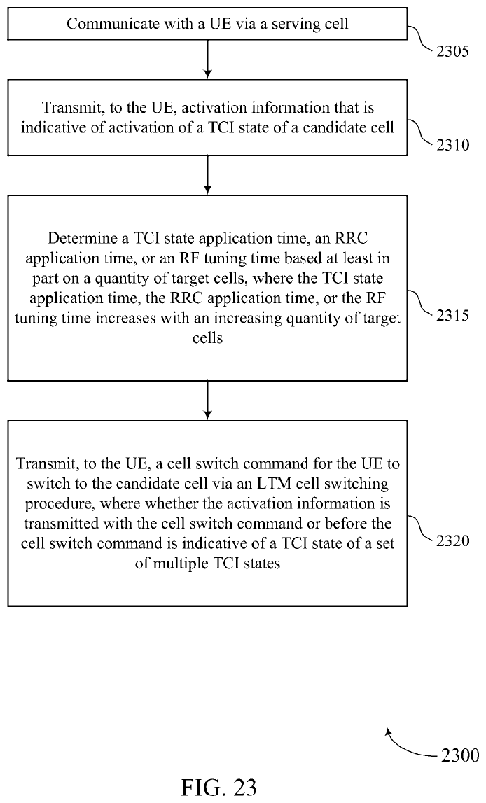

FIG. 23 shows a flowchart illustrating a method 2300 that supports TCI activation in a candidate cell in accordance with aspects of the present disclosure. The operations of the method 2300 may be implemented by a network entity or its components as described herein. For example, the operations of the method 2300 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 2305, the method may include communicating with a UE via a serving cell. The operations of block 2305 may be performed in accordance with examples as disclosed herein. In some examples, aspects of the operations of 2305 may be performed by a service manager 1425 as described with reference to FIG. 14.

At 2310, the method may include transmitting, to the UE, activation information that is indicative of activation of a TCI state of a candidate cell. The operations of block 2310 may be performed in accordance with examples as disclosed herein. In some examples, aspects of the operations of 2310 may be performed by an activation manager 1440 as described with reference to FIG. 14.

At 2315, the method may include determining a TCI state application time, an RRC application time, or an RF tuning time based at least in part on a quantity of target cells, where the TCI state application time, the RRC application time, or the RF tuning time increases with an increasing quantity of target cells. The operations of block 2315 may be performed in accordance with examples as disclosed herein. In some examples, aspects of the operations of 2315 may be performed by an application manager 1450 as described with reference to FIG. 14.

At 2320, the method may include transmitting, to the UE, a cell switch command for the UE to switch to the candidate cell via an LTM cell switching procedure, where whether the activation information is transmitted with the cell switch command or before the cell switch command is indicative of a TCI state of a set of multiple TCI states. The operations of block 2320 may be performed in accordance with examples as disclosed herein. In some examples, aspects of the operations of 2320 may be performed by a switch manager 1435 as described with reference to FIG. 14.

The following provides an overview of aspects of the present disclosure:

Aspect 1: A method for wireless communication at a UE, comprising: receiving, via a serving cell, control information that is indicative of one or more BWPs, wherein the one or more BWPs are associated with an activated TCI state of a candidate cell; receiving, via the serving cell, a cell switch command that indicates for the UE to switch to the candidate cell via an LTM cell switching procedure; and communicating one or more messages with the candidate cell in accordance with the cell switch command and the activated TCI state using the one or more BWPs of the candidate cell.

Aspect 2: The method of aspect 1, wherein the one or more BWPs are indicated by inclusion, in the control information, of a BWP identifier of the candidate cell, and the control information is received via a TCI activation MAC-CE or via a cell switch MAC-CE.

Aspect 3: The method of aspect 1, wherein association of the one or more BWPs with the activated TCI state is via a rule applied to the control information.

Aspect 4: The method of aspect 3, wherein the control information is received via an RRC configuration message, and the rule indicates that the one or more BWPs include a first active BWP configured via the RRC configuration message or an initial BWP configured via the RRC configuration message.

Aspect 5: The method of aspect 3, wherein the control information is an indication of the activated TCI state and is received separate from candidate cell configuration signaling and serving cell configuration signaling and lacks an indication of the one or more BWPs, and the rule indicates that, based at least in part on lack of the indication of the one or more BWPs in the control information, the one or more BWPs include a plurality of BWPs within a bandwidth of the candidate cell.

Aspect 6: The method of aspect 1, wherein the one or more BWPs are indicated by inclusion, in the control information, of a BWP identifier for a QCL'd source reference signal of the activated TCI state of the candidate cell, and wherein the control information is received via an RRC configuration message.

Aspect 7: The method of aspect 1, wherein association of the one or more BWPs with a QCL'd source reference signal of the activated TCI state is via a rule applied to the control information.

Aspect 8: The method of aspect 7, wherein the control information is received via an RRC configuration message, and the rule indicates that the one or more BWPs, associated with the QCL'd source reference signal, include a first active BWP configured via the RRC configuration message or an initial BWP configured via the RRC configuration message.

Aspect 9: The method of aspect 7, wherein the control information is an indication of the activated TCI state and is received separate from candidate cell configuration signaling and serving cell configuration signaling and lacks an indication of the one or more BWPs, and the rule indicates that, based at least in part on lack of the indication of the one or more BWPs in the control information, the one or more BWPs include a plurality of BWPs, for the QCL'd source reference signal, within a bandwidth of the candidate cell.

Aspect 10: The method of aspect 9, wherein the QCL'd source reference signal is configured as a CSI-RS for mobility, is configured as a CSI-RS with an associated frequency allocation, or is configured as an SSB with an associated frequency allocation.

Aspect 11: The method of any of aspects 1 through 10, wherein the activated TCI state is one of a plurality of activated TCI states for a corresponding plurality of candidate cells, the method further comprising: determining a TCI state application time as a maximum TCI state application time among a plurality of TCI state application times respectively associated with the plurality of activated TCI states and with a plurality of target cells, wherein communicating with the candidate cell comprises communicating via at least one beam in accordance with the TCI state application time.

Aspect 12: The method of any of aspects 1 through 10, wherein the activated TCI state is one of a plurality of activated TCI states for a corresponding plurality of candidate cells, the method further comprising: determining a TCI state application time as a sum of a plurality of TCI state application times respectively associated with the plurality of activated TCI states and with a plurality of target cells, wherein communicating with the candidate cell comprises communicating via at least one beam in accordance with the TCI state application time.

Aspect 13: The method of any of aspects 1 through 10, further comprising: determining a TCI state application time, an RRC application time, or an RF tuning time based at least in part on a quantity of target cells, wherein the TCI state application time, the RRC application time, or the RF tuning time increases with an increasing quantity of target cells, and wherein communicating with the candidate cell comprises communicating in accordance with the TCI state application time, the RRC application time, or the RF tuning time.

Aspect 14: The method of any of aspects 1 through 10, further comprising: determining a respective TCI state application time for each of a plurality of target cells, and wherein communicating with the candidate cell comprises communicating via a plurality of beams in accordance with the respective TCI state application time for each of the plurality of target cells.

Aspect 15: A method for wireless communication at a UE, comprising: receiving, via a serving cell, activation information that is indicative of activation of a TCI state of a candidate cell; receiving, via the serving cell, a cell switch command for the UE to switch to the candidate cell via an LTM cell switching procedure, wherein a determination of a TCI state of a plurality of TCI states is based at least in part on whether the activation information is received with the cell switch command or before the cell switch command; and communicating with the candidate cell in accordance with the cell switch command and the TCI state.

Aspect 16: The method of aspect 15, further comprising: determining the TCI state based at least in part on a TCI codepoint index received via the cell switch command when the activation information is received before the cell switch command, and wherein communicating with the candidate cell is performed with one or more TRPs.

Aspect 17: The method of any of aspects 15 through 16, further comprising: determining the TCI state based at least in part on a plurality of TCI codepoint indexes associated with different control resource set indexes, wherein the plurality of TCI codepoint indexes is received via the cell switch command when the activation information is received before the cell switch command, and wherein communicating with the candidate cell is performed with a plurality of TRPs.

Aspect 18: The method of aspect 15, further comprising: determining the TCI state based at least in part on a TCI state index received via the cell switch command when the activation information is received with the cell switch command, and wherein communicating with the candidate cell is performed with a TRP.

Aspect 19: The method of aspect 18, further comprising: determining the TCI state based at least in part on a plurality of TCI state indexes received via the cell switch command when the activation information is received with the cell switch command, and wherein communicating with the candidate cell is performed with a plurality of TRPs.

Aspect 20: The method of any of aspects 18 through 19, wherein the activation information, the cell switch command, and a beam indication are received via a MAC-CE message.

Aspect 21: The method of any of aspects 15 through 17, wherein the activation information and a beam indication are received via at least one first MAC-CE message before the cell switch command, and the cell switch command is received via at least one second MAC-CE message.

Aspect 22: The method of any of aspects 15 through 21, wherein communicating with the candidate cell comprises: communicating on one or more channels with the candidate cell in accordance with the TCI state and a beam indicated via the cell switch command.

Aspect 23: The method of any of aspects 15 through 22, wherein the activated TCI state is one of a plurality of activated TCI states for a corresponding plurality of candidate cells, the method further comprising: determining a TCI state application time as a maximum TCI state application time among a plurality of TCI state application times respectively associated with the plurality of activated TCI states and with a plurality of target cells, wherein communicating with the candidate cell comprises communicating via at least one beam in accordance with the TCI state application time.

Aspect 24: The method of any of aspects 15 through 22, wherein the activated TCI state is one of a plurality of activated TCI states for a corresponding plurality of candidate cells, the method further comprising: determining a TCI state application time as a sum of a plurality of TCI state application times respectively associated with the plurality of activated TCI states and with a plurality of target cells, wherein communicating with the candidate cell comprises communicating via at least one beam in accordance with the TCI state application time.

Aspect 25: The method of any of aspects 15 through 22, further comprising: determining a TCI state application time, an RRC application time, or an RF tuning time based at least in part on a quantity of target cells, wherein the TCI state application time, the RRC application time, or the RF tuning time increases with an increasing quantity of target cells, and wherein communicating with the candidate cell comprises communicating in accordance with the TCI state application time, the RRC application time, or the RF tuning time.

Aspect 26: The method of any of aspects 15 through 22, further comprising: determining a respective TCI state application time for each of a plurality of target cells, and wherein communicating with the candidate cell comprises communicating via a plurality of beams in accordance with the respective TCI state application time for each of the plurality of target cells.

Aspect 27: A method for wireless communication at a network entity, comprising: communicating with a UE via a serving cell; transmitting, to the UE, control information that is indicative of one or more BWPs, wherein the one or more BWPs are associated with an activated TCI state of a candidate cell; and transmitting, to the UE, a cell switch command that indicates for the UE to switch to the candidate cell via an LTM cell switching procedure.

Aspect 28: The method of aspect 27, wherein the one or more BWPs are indicated by inclusion, in the control information, of a BWP identifier of the candidate cell, and the control information is transmitted via a TCI activation MAC-CE or via a cell switch MAC-CE.

Aspect 29: The method of aspect 27, wherein association of the one or more BWPs with the activated TCI state is via a rule applied to the control information.

Aspect 30: The method of aspect 29, wherein the control information is transmitted via an RRC configuration message, and the rule indicates that the one or more BWPs include a first active BWP configured via the RRC configuration message or an initial BWP configured via the RRC configuration message.

Aspect 31: The method of aspects 29, wherein the control information is an indication of the activated TCI state and is transmitted separate from candidate cell configuration signaling and serving cell configuration signaling and lacks an indication of the one or more BWPs, and the rule indicates that, based at least in part on lack of the indication of the one or more BWPs in the control information, the one or more BWPs include a plurality of BWPs within a bandwidth of the candidate cell.

Aspect 32: The method of aspect 27, wherein the one or more BWPs are indicated by inclusion, in the control information, of a BWP identifier for a QCL'd source reference signal of the activated TCI state of the candidate cell, and wherein the control information is transmitted via an RRC configuration message.

Aspect 33: The method of aspect 27, wherein association of the one or more BWPs with a QCL'd source reference signal of the activated TCI state is via a rule applied to the control information.

Aspect 34: The method of aspect 33, wherein the control information is transmitted via an RRC configuration message, and the rule indicates that the one or more BWPs, associated with the QCL'd source reference signal, include a first active BWP configured via the RRC configuration message or an initial BWP configured via the RRC configuration message.

Aspect 35: The method of any of aspects 33, wherein the control information is an indication of the activated TCI state and is transmitted separate from candidate cell configuration signaling and serving cell configuration signaling and lacks an indication of the one or more BWPs, and the rule indicates that, based at least in part on lack of the indication of the one or more BWPs in the control information, the one or more BWPs include a plurality of BWPs, for the QCL'd source reference signal, within a bandwidth of the candidate cell.

Aspect 36: The method of aspect 35, wherein the QCL'd source reference signal is configured as a CSI-RS for mobility, is configured as a CSI-RS with an associated frequency allocation, or is configured as an SSB with an associated frequency allocation.

Aspect 37: The method of any of aspects 27 through 36, wherein the activated TCI state is one of a plurality of activated TCI states for a corresponding plurality of candidate cells, the method further comprising: determining a TCI state application time as a maximum TCI state application time among a plurality of TCI state application times respectively associated with the plurality of activated TCI states and with a plurality of target cells.

Aspect 38: The method of any of aspects 27 through 36, wherein the activated TCI state is one of a plurality of activated TCI states for a corresponding plurality of candidate cells, the method further comprising: determining a TCI state application time as a sum of a plurality of TCI state application times respectively associated with the plurality of activated TCI states and with a plurality of target cells.

Aspect 39: The method of any of aspects 27 through 36, further comprising: determining a TCI state application time, an RRC application time, or an RF tuning time based at least in part on a quantity of target cells, wherein the TCI state application time, the RRC application time, or the RF tuning time increases with an increasing quantity of target cells.

Aspect 40: The method of any of aspects 27 through 36, further comprising: determining a respective TCI state application time for each of a plurality of target cells.

Aspect 41: A method for wireless communication at a network entity, comprising: communicating with a UE via a serving cell; transmitting, to the UE, activation information that is indicative of activation of a TCI state of a candidate cell; and transmitting, to the UE, a cell switch command for the UE to switch to the candidate cell via an LTM cell switching procedure, wherein whether the activation information is transmitted with the cell switch command or before the cell switch command is indicative of a TCI state of a plurality of TCI states.

Aspect 42: The method of aspect 41, wherein when the activation information is transmitted before the cell switch command, a TCI codepoint index transmitted via the cell switch command is indicative of the TCI state.

Aspect 43: The method of any of aspects 41 through 42, wherein when the activation information is transmitted before the cell switch command, a plurality of TCI codepoint indexes associated with different control resource set indexes is indicative of the TCI state, wherein the plurality of TCI codepoint indexes is transmitted via the cell switch command.

Aspect 44: The method of aspect 41, wherein when the activation information is transmitted with the cell switch command, a TCI state index transmitted via the cell switch command is indicative of the TCI state.

Aspect 45: The method of aspect 44, wherein when the activation information is transmitted with the cell switch command, a plurality of TCI state indexes transmitted via the cell switch command is indicative of the TCI state.

Aspect 46: The method of any of aspects 44 through 45, wherein the activation information, the cell switch command, and a beam indication are transmitted via a MAC-CE message.

Aspect 47: The method of any of aspects 41 through 43, wherein the activation information and a beam indication are transmitted via at least one first MAC-CE message before the cell switch command, and the cell switch command is transmitted via at least one second MAC-CE message.

Aspect 48: The method of any of aspects 41 through 47, wherein the activated TCI state is one of a plurality of activated TCI states for a corresponding plurality of candidate cells, the method further comprising: determining a TCI state application time as a maximum TCI state application time among a plurality of TCI state application times respectively associated with the plurality of activated TCI states and with a plurality of target cells.

Aspect 49: The method of any of aspects 41 through 47, wherein the activated TCI state is one of a plurality of activated TCI states for a corresponding plurality of candidate cells, the method further comprising: determining a TCI state application time as a sum of a plurality of TCI state application times respectively associated with the plurality of activated TCI states and with a plurality of target cells.

Aspect 50: The method of any of aspects 41 through 47, further comprising: determining a TCI state application time, an RRC application time, or an RF tuning time based at least in part on a quantity of target cells, wherein the TCI state application time, the RRC application time, or the RF tuning time increases with an increasing quantity of target cells.

Aspect 51: The method of any of aspects 41 through 47, further comprising: determining a respective TCI state application time for each of a plurality of target cells.

Aspect 52: A UE for wireless communication, comprising at least one processor, memory coupled (e.g., operatively, communicatively, functionally, electronically, or electrically) with the at least one processor, and instructions stored in the memory, the instructions executable by the at least one processor to cause the UE to perform a method of any of aspects 1 through 14.

Aspect 53: A UE for wireless communication, comprising at least one means for performing a method of any of aspects 1 through 14.

Aspect 54: A non-transitory computer-readable medium storing code for wireless communication, the code comprising instructions executable by at least one processor (e.g., directly, indirectly, after pre-processing, without pre-processing) to perform a method of any of aspects 1 through 14.

Aspect 55: A UE for wireless communication, comprising at least one processor, memory coupled (e.g., operatively, communicatively, functionally, electronically, or electrically) with the at least one processor, and instructions stored in the memory, the instructions executable by the at least one processor to cause the UE to perform a method of any of aspects 15 through 26.

Aspect 56: A UE for wireless communication, comprising at least one means for performing a method of any of aspects 15 through 26.

Aspect 57: A non-transitory computer-readable medium storing code for wireless communication, the code comprising instructions executable by at least one processor (e.g., directly, indirectly, after pre-processing, without pre-processing) to perform a method of any of aspects 15 through 26.

Aspect 58: A network entity for wireless communication, comprising at least one processor, memory coupled (e.g., operatively, communicatively, functionally, electronically, or electrically) with the at least one processor, and instructions stored in the memory, the instructions executable by the at least one processor to cause the network entity to perform a method of any of aspects 27 through 40.

Aspect 59: A network entity for wireless communication, comprising at least one means for performing a method of any of aspects 27 through 40.

Aspect 60: A non-transitory computer-readable medium storing code for wireless communication, the code comprising instructions executable by at least one processor (e.g., directly, indirectly, after pre-processing, without pre-processing) to perform a method of any of aspects 27 through 40.

Aspect 61: A network entity for wireless communication, comprising at least one processor, memory coupled (e.g., operatively, communicatively, functionally, electronically, or electrically) with the at least one processor, and instructions stored in the memory, the instructions executable by the at least one processor to cause the network entity to perform a method of any of aspects 41 through 51.

Aspect 62: A network entity for wireless communication, comprising at least one means for performing a method of any of aspects 41 through 51.

Aspect 63: A non-transitory computer-readable medium storing code for wireless communication, the code comprising instructions executable by at least one processor (e.g., directly, indirectly, after pre-processing, without pre-processing) to perform a method of any of aspects 41 through 51. It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., including a list of items prefaced by a phrase such as “at least one of” or “one or more of”) indicates an inclusive list such that, for example, a list of at least one of A, B, or C means, e.g., A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a user equipment (UE), comprising:
at least one processor; and
memory coupled with the at least one processor, the memory storing instructions executable by the at least one processor to cause the UE to:
receive, via a serving cell, control information that is indicative of one or more bandwidth parts, wherein the one or more bandwidth parts are associated with an activated transmission configuration indicator state of a candidate cell;
receive, via the serving cell, a cell switch command that indicates for the UE to switch to the candidate cell via a layer 1 or layer 2 triggered mobility cell switching procedure; and
communicate one or more messages with the candidate cell in accordance with the cell switch command and the activated transmission configuration indicator state using the one or more bandwidth parts of the candidate cell.

2. The apparatus of claim 1, wherein:
the one or more bandwidth parts are indicated by inclusion, in the control information, of a bandwidth part identifier of the candidate cell, and
the control information is received via a transmission configuration indicator activation medium access control-control element or via a cell switch medium access control-control element.

3. The apparatus of claim 1, wherein association of the one or more bandwidth parts with the activated transmission configuration indicator state is via a rule applied to the control information.

4. The apparatus of claim 3, wherein:
the control information is received via a radio resource control configuration message, and
the rule indicates that the one or more bandwidth parts include a first active bandwidth part configured via the radio resource control configuration message or an initial bandwidth part configured via the radio resource control configuration message.

5. The apparatus of claim 3, wherein:
the control information is an indication of the activated transmission configuration indicator state and is received separate from candidate cell configuration signaling and serving cell configuration signaling and lacks an indication of the one or more bandwidth parts, and
the rule indicates that, based at least in part on lack of the indication of the one or more bandwidth parts in the control information, the one or more bandwidth parts include a plurality of bandwidth parts within a bandwidth of the candidate cell.

6. The apparatus of claim 1, wherein the one or more bandwidth parts are indicated by inclusion, in the control information, of a bandwidth part identifier for a quasi co-located source reference signal of the activated transmission configuration indicator state of the candidate cell, and wherein the control information is received via a radio resource control configuration message.

7. The apparatus of claim 1, wherein association of the one or more bandwidth parts with a quasi co-located source reference signal of the activated transmission configuration indicator state is via a rule applied to the control information.

8. The apparatus of claim 7, wherein:
the control information is received via a radio resource control configuration message, and
the rule indicates that the one or more bandwidth parts, associated with the quasi co-located source reference signal, include a first active bandwidth part configured via the radio resource control configuration message or an initial bandwidth part configured via the radio resource control configuration message.

9. The apparatus of claim 7, wherein:
the control information is an indication of the activated transmission configuration indicator state and is received separate from candidate cell configuration signaling and serving cell configuration signaling and lacks an indication of the one or more bandwidth parts, and
the rule indicates that, based at least in part on lack of the indication of the one or more bandwidth parts in the control information, the one or more bandwidth parts include a plurality of bandwidth parts, for the quasi co-located source reference signal, within a bandwidth of the candidate cell.

10. The apparatus of claim 9, wherein the quasi co-located source reference signal is configured as a channel state information reference signal for mobility, is configured as a channel state information reference signal with an associated frequency allocation, or is configured as a synchronization signal block with an associated frequency allocation.

11. The apparatus of claim 1, wherein the activated transmission configuration indicator state is one of a plurality of activated transmission configuration indicator states for a corresponding plurality of candidate cells, and the instructions are further executable by the at least one processor to cause the UE to determine a transmission configuration indicator state application time as a maximum transmission configuration indicator state application time among a plurality of transmission configuration indicator state application times respectively associated with the plurality of activated transmission configuration indicator states and with a plurality of target cells, wherein communication with the candidate cell comprises communicating via at least one beam in accordance with the transmission configuration indicator state application time.

12. The apparatus of claim 1, wherein the activated transmission configuration indicator state is one of a plurality of activated transmission configuration indicator states for a corresponding plurality of candidate cells, and the instructions are further executable by the at least one processor to cause the UE to determine a transmission configuration indicator state application time as a sum of a plurality of transmission configuration indicator state application times respectively associated with the plurality of activated transmission configuration indicator states and with a plurality of target cells, wherein communication with the candidate cell comprises communicating via at least one beam in accordance with the transmission configuration indicator state application time.

13. The apparatus of claim 1, wherein the instructions are further executable by the at least one processor to cause the UE to:
determine a transmission configuration indicator state application time, a radio resource control application time, or a radio frequency tuning time based at least in part on a quantity of target cells, wherein the transmission configuration indicator state application time, the radio resource control application time, or the radio frequency tuning time increases with an increasing quantity of target cells, and wherein communication with the candidate cell comprises communicating in accordance with the transmission configuration indicator state application time, the radio resource control application time, or the radio frequency tuning time.

14. The apparatus of claim 1, wherein the instructions are further executable by the at least one processor to cause the UE to:
determine a respective transmission configuration indicator state application time for each of a plurality of target cells, and wherein communication with the candidate cell comprises communicating via a plurality of beams in accordance with the respective transmission configuration indicator state application time for each of the plurality of target cells.

15. An apparatus for wireless communication at a user equipment (UE), comprising:
at least one processor; and
memory coupled with the at least one processor, the memory storing instructions executable by the at least one processor to cause the UE to:
receive, via a serving cell, activation information that is indicative of activation of a transmission configuration indicator state of a candidate cell;
receive, via the serving cell, a cell switch command for the UE to switch to the candidate cell via a layer 1 or layer 2 triggered mobility cell switching procedure, wherein a determination of a transmission configuration indicator state of a plurality of transmission configuration indicator states is based at least in part on whether the activation information is received with the cell switch command or before the cell switch command; and
communicate with the candidate cell in accordance with the cell switch command and the transmission configuration indicator state.

16. The apparatus of claim 15, wherein the instructions are further executable by the at least one processor to cause the UE to:
determine the transmission configuration indicator state based at least in part on a transmission configuration indicator codepoint index received via the cell switch command when the activation information is received before the cell switch command, and wherein the communication with the candidate cell is performed with one or more transmission and reception points.

17. The apparatus of claim 15, wherein the instructions are further executable by the at least one processor to cause the UE to:
determine the transmission configuration indicator state based at least in part on a plurality of transmission configuration indicator codepoint indexes associated with different control resource set indexes, wherein the plurality of transmission configuration indicator codepoint indexes is received via the cell switch command when the activation information is received before the cell switch command, and wherein the communication with the candidate cell is performed with a plurality of transmission and reception points.

18. The apparatus of claim 15, wherein the instructions are further executable by the at least one processor to cause the UE to:
determine the transmission configuration indicator state based at least in part on a transmission configuration indicator state index received via the cell switch command when the activation information is received with the cell switch command, and wherein the communication with the candidate cell is performed with a transmission and reception point.

19. The apparatus of claim 15, wherein the instructions are further executable by the at least one processor to cause the UE to:
determine the transmission configuration indicator state based at least in part on a plurality of transmission configuration indicator state indexes received via the cell switch command when the activation information is received with the cell switch command, and wherein the communication with the candidate cell is performed with a plurality of transmission and reception points.

20.-24. (canceled)

25. A method for wireless communication at a user equipment (UE), comprising:
receiving, via a serving cell, control information that is indicative of one or more bandwidth parts, wherein the one or more bandwidth parts are associated with an activated transmission configuration indicator state of a candidate cell;
receiving, via the serving cell, a cell switch command that indicates for the UE to switch to the candidate cell via a layer 1 or layer 2 triggered mobility cell switching procedure; and
communicating one or more messages with the candidate cell in accordance with the cell switch command and the activated transmission configuration indicator state using the one or more bandwidth parts of the candidate cell.

26.-30. (canceled)
